(19) United States
(12) Patent Application Publication
(10) Pub. No.: US 2005/0154097 A1
(43) Pub. Date: Jul. 14, 2005

(54) Stabilized articles

(76) Inventor: Michela Bonora, Bologna (IT)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/512,799

(22) PCT Filed: May 22, 2003
(86) PCT No.: PCT/EP03/05373

(30) Foreign Application Priority Data
May 30, 2002 (EP) 02405435.5

(51) Int. Cl. C08K 5/34; C08K 5/48

(52) U.S. Cl. 524/90

(57) ABSTRACT

The present invention relates to non-agriculture articles which keep their properties during the use and degrade later on, until total disintegration and disappearance of the plastic. The invention further relates to a method for controlling the weathering resistance and the degradation of non-agricultural articles. The desired effect is obtained with specific combinations of degradant metals salts and stabilizers. The non-agricultural article of the present invention comprises an organic polymer, an organic salt of Fe, Ce Co Mn, Cu or Vd and one more sterically hindered amino compounds.

The present invention relates to non-agricultural articles which keep their properties during the use and degrade later on, until total disintegration and disappearance of the plastic. The invention further relates to a method for controlling the weathering resistance and the degradation of non-agricultural articles. The desired effect is obtained with specific combinations of degradant metal salts and stabilizers.

A brief description of some exemplary non-agricultural articles made in accordance with the invention follows. Typically, the articles are required to have a relatively long service life followed by a relatively short period during which embrittlement and fragmentation occurs, either in situ or in a landfill. The articles may be film products comprising polyolefins or other organic polymers.

(a) Geotextiles. These are films, woven or spun-bonded fabrics that are used in civil engineering projects, primarily for temporary soil stabilization. In road and bridge building operations, for example, it is necessary that soil embankments and road base materials be stabilized and consolidated until trees, brushes and grass become established, typically for periods of six to eighteen months. Likewise, ditches and other drainage devices require temporary consolidation. When the service requirements are over, the material can degrade and be assimilated harmlessly into the surrounding environment.

(b) Multiple-use landfill covers. These can be used to cover a landfill active face overnight, pulled off in the morning and re-deployed at the end of the day. After some weeks, mechanical damage requires that the thick film cover be replaced. The pieces of the old cover can then undergo oxo-biodegradation after burial in the landfill.

(c) Industrial covers. Such covers, including tarpaulins and pallet wraps, are frequently required to provide protection for weeks or months and are then discarded after mechanical damage has rendered them no longer useful. Such covers will degrade in a landfill if made in accordance with the present invention. Other industrial covers in accordance with the invention include the wrappings for kiln-dried lumber, for new cars and boats during storage and transportation; temporary enclosures for buildings during repairs (for example, leaky condos) seasonal outdoor displays; covers for mining applications and oil rig applications, to cover and protect the work areas for the period of the year when the work cannot be done; covers for mothballing applications, for covering equipment such as chemical or oil industry equipment that has to be preserved for a time when not in use. All such covers and wrappings made in accordance with the invention can be disposed of in landfills after their service life and then undergo degradation.

(d) Waste covers, including covers and liners used in the construction or operation of a landfill. These have a service life that may be from several days to several months, depending upon the application. After their service life, they can degrade in the landfill.

(e) Temporary scaffolding sheets. These are used in the construction industry to protect inside surfaces during repairs. Their service life is typically between about three and eight months. After their service life, they can be disposed of and degrade in a landfill.

(f) Building films. These are used to protect some parts of a building during construction or repairs. Their service life is typically between two months and one year.

(g) Silt fences. These are used to protect temporarily some repair work or construction done on highways, fences, etc. Their service life is typically up to about one year.

(h) Flexible packaging wraps. These are used in the lumber and steel industries to protect lumber and metal goods during transportation and storage.

(i) Poultry curtains, made of polymer films. These are used in poultry farms to build temporary walls.

(j) Films for building temporary shelter constructions, such as emergency shelters.

In all of the foregoing examples, the non-agricultural article, made in accordance with the invention, will keep its properties during use and will degrade after its service life.

The invention also relates to a method for controlling the weather resistance and the degradation of a non-agricultural organic polymer article, for example articles of the types described above, which comprises incorporating into the organic polymer components (II) and (III) as defined below.

The invention also relates to a composition comprising components (II) and (III), and optionally one or more of components (IV), (V), (VI), (VII) or (VIII) as defined below, for incorporation with an organic polymer to form a non-agricultural article.

The invention also relates to the use of a mixture containing components (II) and (III), and optionally one or more of components (IV), (V), (VI), (VII) or (VIII) as defined below, for controlling the weathering resistance and the degradation of a non-agricultural organic polymer article.

The non-agricultural article of the present invention comprises an organic polymer, an organic salt of Fe, Ce, Co, Mn, Cu or Vd and one or more sterically hindered amine compounds.

Shelf stable nonwoven fabrics and films are disclosed in U.S. Pat. No. 5,393,831. A method for controlling the degradation start time is further disclosed in JP-A-05/043749. Chemically degradable polyolefin films are also described in U.S. Pat. No. 5,565,503.

Stabilized plastics are for example described in EP-A-226,453, GB-A-1,582,280, U.S. Pat. No. 3,909,333, U.S. Pat. No. 5,859,098, DE-A-4,003,129 and EP-A-172,691.

The present invention relates in particular to a non-agricultural article comprising the components
(I) an organic polymer,
(II) an organic salt of Fe, Ce, Co, Mn, Cu or Vd, and
(III) one or more sterically hindered amine compounds selected from the group consisting of
   a compound of the formula (A-1) 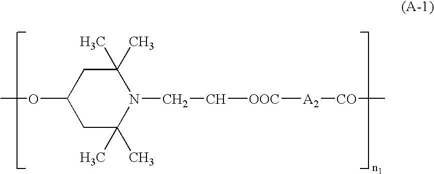
   wherein
A₁ is hydrogen or C₁-C₄alkyl,
A₂ is a direct bond or C₁-C₁₀alkylene, and
n₁ is a number from 2 to 50;
   at least one compound of the formulae (A-2-a) and (A-2-b) 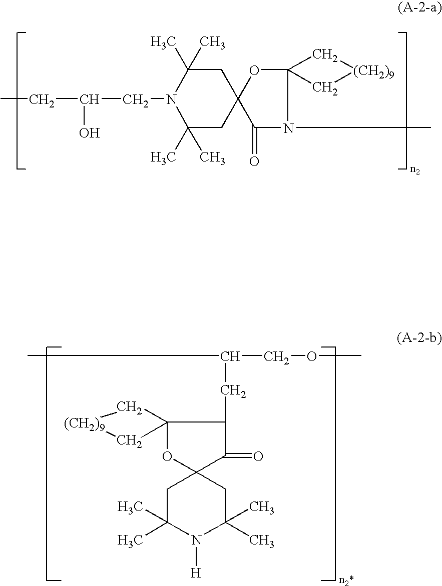
   wherein
n₂ and n₂* are a number from 2 to 50;
   a compound of the formula (A-3) 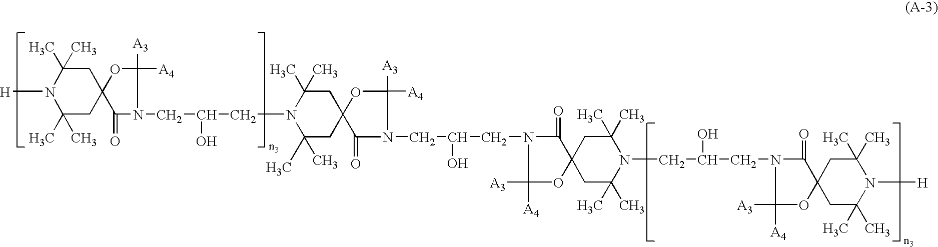
   wherein
A₃ and A₄ independently of one another are hydrogen or C₁-C₈alkyl, or A₃ and A₄ together form a C₂-C₁₄alkylene group, and
the variables n₃ independently of one another are a number from 1 to 50;
   a compound of the formula (A-4) 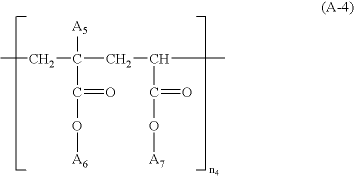
   wherein
n₄ is a number from 2 to 50,
A₅ is hydrogen or C₁-C₄alkyl,
the radicals A₆ and A₇ independently of one another are C₁-C₄alkyl or a group of the formula (a-I) 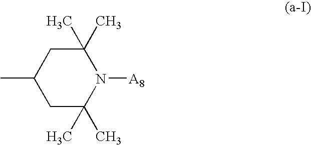
   wherein A₈ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl,
   with the proviso that at least 50% of the radicals A₇ are a group of the formula (a-I);
   a compound of the formula (B-1) 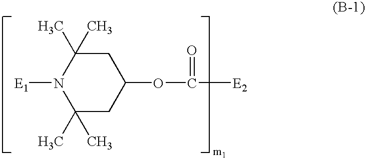
   in which
E₁ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl,
m₁ is 1, 2 or 4,
if m₁ is 1, E₂ is C₁-C₂₅alkyl,
if m₁ is 2, E₂ is C₁-C₁₄alkylene or a group of the formula (b-I) 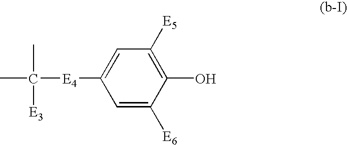
   wherein E₃ is C₁-C₁₀alkyl or C₂-C₁₀alkenyl, E₄ is C₁-C₁₀alkylene, and
E₅ and E₈ independently of one another are C₁-C₄alkyl, cyclohexyl or methylcyclohexyl, and
if m₁ is 4, E₂ is C₄-C₁₀alkanetetrayl;
   a compound of the formula (B-2) 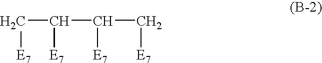
   in which
two of the radicals E₇ are —COO—(C₁-C₂₀alkyl), and
two of the radicals E₇ are a group of the formula (b-II) 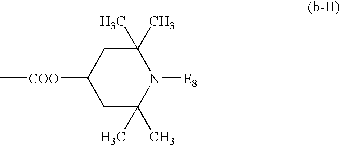
   with E₈ having one of the meanings of E₁;
   a compound of the formula (B-3) 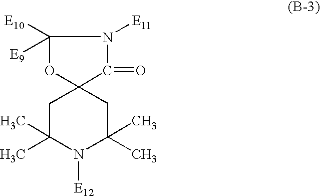
   in which
E₉ and E₁₀ together form C₂-C₁₄alkylene,
E₁₁ is hydrogen or a group -Z₁-COO-Z₂,
Z₁ is C₂-C₁₄alkylene, and
Z₂ is C₁-C₂₄alkyl, and
E₁₂ has one of the meanings of E₁;
   a compound of the formula (B-4) 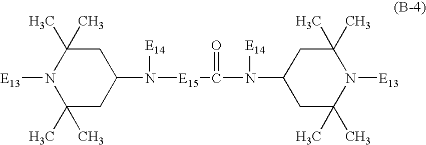
   wherein
the radicals E₁₃ independently of one another have one of the meanings of E₁,
the radicals E₁₄ independently of one another are hydrogen or C₁-C₁₂alkyl, and E₁₅ is C₁-C₁₀alkylene or C₃-C₁₀alkylidene;
   a compound of the formula (B-5) 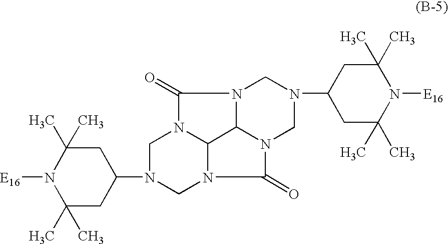
   wherein
the radicals E₁₆ independently of one another have one of the meanings of E₁;
   a compound of the formula (B-6) 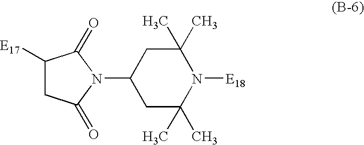
   in which
E₁₇ is C₁-C₂₄alkyl, and
E₁₈ has one of the meanings of E₁;
   a compound of the formula (B-7) 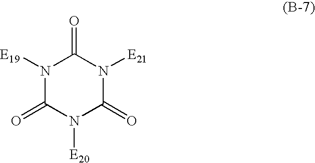
   in which
E₁₉, E₂₀ and E₂₁ independently of one another are a group of the formula (b-III) 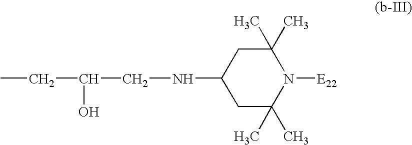
   wherein E₂₂ has one of the meanings of E₁;
   a compound of the formula (B-8) 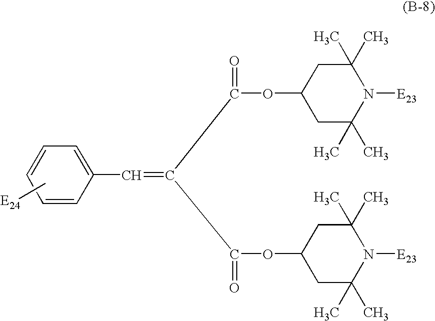
   wherein
the radicals E₂₃ independently of one another have one of the meanings of E₁, and E₂₄ is hydrogen, C₁-C₁₂alkyl or C₁-C₁₂alkoxy;
   a compound of the formula (B-9) 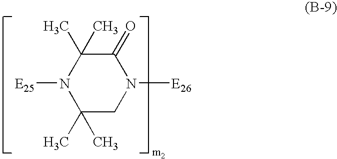
   wherein
m₂ is 1, 2 or 3,
E₂₅ has one of the meanings of E₁, and
when m₂ is 1, E₂₆ is a group 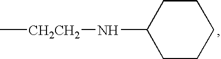
when m₂ is 2, E₂₆ is C₂-C₂₂alkylene, and
when m₂ is 3, E₂₆ is a group of the formula (b-IV) 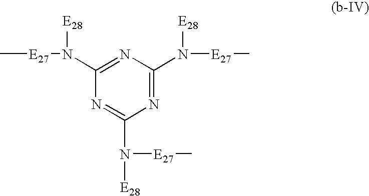
   wherein the radicals E₂₇ independently of one another are C₂-C₁₂alkylene, and the radicals E₂₈ independently of one another are C₁-C₁₂alkyl or C₅-C₁₂cycloalkyl;
   a compound of the formula (B-10) 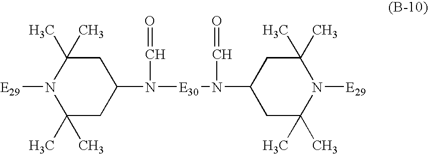
   wherein
the radicals E₂₉ independently of one another have one of the meanings of E₁, and E₃₀ is C₂-C₂₂alkylene, C₅-C₇cycloalkylene, C₁-C₄alkylenedi(C₅-C₇cycloalkylene), phenylene or phenylenedi(C₁-C₄alkylene);
   a compound of the formula (C-1) 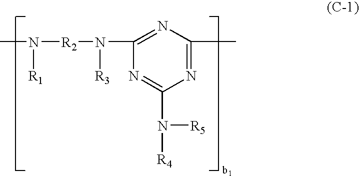
   in which
R₁, R₃, R₄ and R₅ independently of one another are hydrogen, C₁-C₁₂alkyl, C₅-C₁₂cycloalkyl, C₁-C₄-alkyl-substituted C₅-C₁₂cycloalkyl, phenyl, phenyl which is substituted by —OH and/or C₁-C₁₀alkyl; C₇-C₉phenylalkyl, C₇-C₉phenylalkyl which is substituted on the phenyl radical by —OH and/or C₁-C₁₀alkyl; or a group of the formula (c-I) 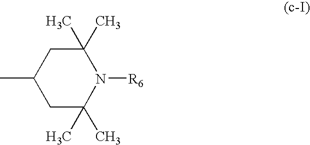
R₂ is C₂-C₁₈alkylene, C₅-C₇cycloalkylene or C₁-C₄alkylenedi(C₅-C₇cycloalkylene), or
the radicals R₁, R₂ and R₃, together with the nitrogen atoms to which they are bonded, perform a 5- to 10-membered heterocyclic ring, or
R₄ and R₅, together with the nitrogen atom to which they are bonded, form a 5- to 10-membered heterocyclic ring,
R₆ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl, and
b₁ is a number from 2 to 50,
with the proviso that at least one of the radicals R₁, R₃, R₄ and R₅ is a group of the formula (c-I);
   a compound of the formula (C-2) 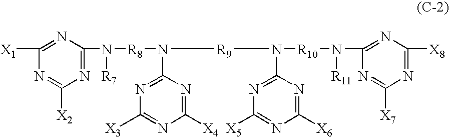
   wherein
R₇ and R₁₁ independently of one another are hydrogen or C₁-C₁₂alkyl,
R₈, R₉ and R₁₀ independently of one another are C₂-C₁₀alkylene, and
X₁, X₂, X₃, X₄, X₅, X₆, X₇ and X₈ independently of one another are a group of the formula (c-II), 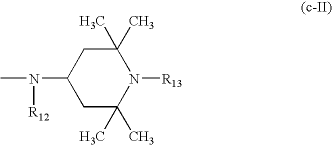
   in which R₁₂ is hydrogen, C₁-C₁₂alkyl, C₅-C₁₂cycloalkyl, C₁-C₄alkyl-substituted C₅-C₁₂cycloalkyl, phenyl, —OH— and/or C₁-C₁₀alkyl-substituted phenyl, C₇-C₉phenylalkyl, C₇-C₉phenylalkyl which is substituted on the phenyl radical by —OH and/or C₁-C₁₀alkyl; or a group of the formula (c-I) as defined above, and
R₁₃ has one of the meanings of R₆;
   a compound of the formula (C-3) 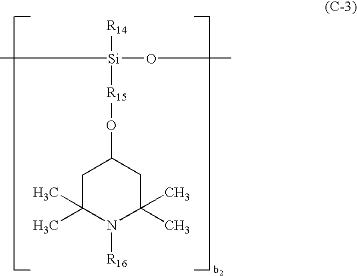
   in which
R₁₄ is C₁-C₁₀alkyl, C₅-C₁₂cycloalkyl, C₁-C₄alkyl-substituted C₅-C₁₂cycloalkyl, phenyl or C₁-C₁₀alkyl-substituted phenyl,
R₁₅ is C₃-C₁₀alkylene,
R₁₆ has one of the meanings of R₆, and
b₂ is a number from 2 to 50;
   a compound of the formula (C-4) 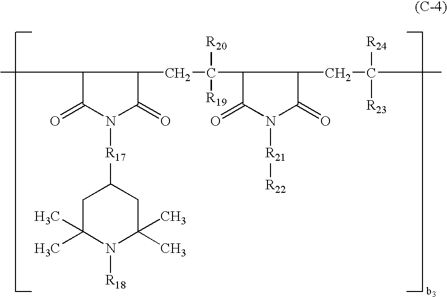
   in which
R₁₇ and R₂₁ independently of one another are a direct bond or a —N(X₉)—CO—X₁₀—CO—N(X₁₁)— group, where X₉ and X₁₁ independently of one another are hydrogen, C₁-C₈alkyl, C₅-C₁₂cycloalkyl, phenyl, C₇-C₉phenylalkyl or a group of the formula (c-I),
X₁₀ is a direct bond or C₁-C₄alkylene,
R₁₈ has one of the meanings of R₆,
R₁₉, R₂₀, R₂₃ and R₂₄ independently of one another are hydrogen, C₁-C₃₀alkyl, C₅-C₁₂cycloalkyl or phenyl,
R₂₂ is hydrogen, C₁-C₃₀alkyl, C₅-C₁₂cycloalkyl, phenyl, C₇-C₉phenylalkyl or a group of the formula (c-I), and
b₃ is a number from 1 to 50;
   a compound of the formula (C-5) 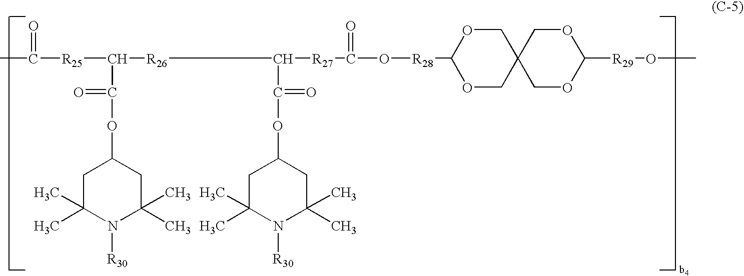
   in which
R₂₅, R₂₆, R₂₇, R₂₈ and R₂₉ independently of one another are a direct bond or C₁-C₁₀alkylene,
R₃₀ has one of the meanings of R₆, and
b₄ is a number from 1 to 50; and
   a product (C-6) obtainable by reacting a product, obtained by reaction of a polyamine of the formula (C-6-1) with cyanuric chloride, with a compound of the formula (C-6-2) 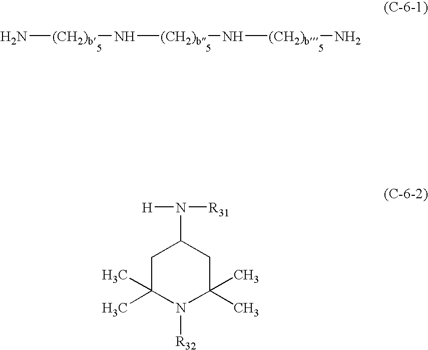
   in which
b′₅, b″₅ and b′″₅ independently of one another are a number from 2 to 12,
R₃₁ is hydrogen, C₁-C₁₂alkyl, C₅-C₁₂cycloalkyl, phenyl or C₇-C₉phenylalkyl, and
R₃₂ has one of the meanings of R₆.

When the non-agricultural article according to the present invention contains a polyolefin, the presence of an oxidizable unsaturated compound, in particular natural rubber, styrene butadiene resin, fat or oil, is preferably disclaimed.

A non-agricultural article which is free of an oxidizable unsaturated compound, in particular natural rubber, styrene butadiene resin, fat or oil, is of special interest.

Examples of alkyl having up to 30 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl, docosyl and triacontyl. One of the preferred definitions of A₈, E₁, E₈, E₁₂, E₁₃, E₁₆, E₁₈ E₂₂, E₂₃, E₂₅, E₂₉, R₆, R₁₃, R₁₆, R₁₈, R₃₀ and R₃₂ is C₁-C₄alkyl, especially methyl. R₃₁ is preferably butyl.

Examples of alkoxy having up to 18 carbon atoms are methoxy, ethoxy, propoxy, isopropoxy, butoxy, isobutoxy, pentoxy, isopentoxy, hexoxy, heptoxy, octoxy, decyloxy, dodecyloxy, tetradecyloxy, hexadecyloxy and octadecyloxy. One of the preferred meanings of E₁ is octoxy. E₂₄ is preferably C₁-C₄alkoxy and one of the preferred meanings of R₆ is propoxy.

Examples of C₅-C₁₂cycloalkyl are cyclopentyl, cyclohexyl, cycloheptyl, cyclooctyl and cyclododecyl. C₅-C₈cycloalkyl, especially cyclohexyl, is preferred.

C₁-C₄Alkyl-substituted CS-C₁₋₂cycloalkyl is for example methylcyclohexyl or dimethylcyclohexyl.

Examples of C₅-C₁₂cycloalkoxy are cyclopentoxy, cyclohexoxy, cycloheptoxy, cyclooctoxy, cyclodecyloxy and cyclododecyloxy. C₅-C₈Cycloalkoxy, in particular cyclopentoxy and cyclohexoxy, is preferred.

—OH— and/or C₁-C₁₀alkyl-substituted phenyl is for example methylphenyl, dimethylphenyl, trimethylphenyl, tert-butylphenyl or 3,5-di-tert-butyl-4-hydroxyphenyl.

Examples of C₇-C₉phenylalkyl are benzyl and phenylethyl.

C₇-C₉Phenylalkyl which is substituted on the phenyl radical by —OH and/or by alkyl having up to 10 carbon atoms is for example methylbenzyl, dimethylbenzyl, trimethylbenzyl, tertbutylbenzyl or 3,5-di-tert-butyl-4-hydroxybenzyl.

Examples of alkenyl having up to 10 carbon atoms are allyl, 2-methallyl, butenyl, pentenyl and hexenyl. Allyl is preferred. The carbon atom in position 1 is preferably saturated.

Examples of acyl containing not more than 8 carbon atoms are formyl, acetyl, propionyl, butyryl, pentanoyl, hexanoyl, heptanoyl, octanoyl, acryloyl, methacryloyl and benzoyl. C₁-C₈Alkanoyl, C₃-C₈alkenyl and benzoyl are preferred. Acetyl and acryloyl are especially preferred.

Examples of alkylene having up to 22 carbon atoms are methylene, ethylene, propylene, trimethylene, tetramethylene, pentamethylene, 2,2-dimethyltrimethylene, hexamethylene, trimethylhexamethylene, octamethylene and decamethylene.

An example of C₃-C₁₀alkylidene is the group

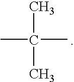

An example of C₄-C₁₀alkanetetrayl is 1,2,3,4-butanetetrayl.

An example of C₅-C₇cycloalkylene is cyclohexylene.

An example of C₁-C₄alkylenedi(C₅-C₇cycloalkylene) is methylenedicyclohexylene.

An example of phenylenedi(C₁-C₄alkylene) is methylene-phenylene-methylene or ethylene-phenylene-ethylene.

Where the radicals R₁, R₂ and R₃, together with the nitrogen atoms to which they are attached, form a 5- to 10-membered heterocyclic ring, this ring is for example

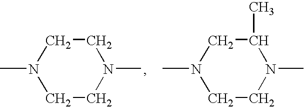

A 6-membered heterocyclic ring is preferred.

Where the radicals R₄ and R₅, together with the nitrogen atom to which they are attached, form a 5- to 10-membered heterocyclic ring, this ring is for example 1-pyrrolidyl, piperidino, morpholino, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl. Morpholino is particularly preferred.

One of the preferred definitions of R₁₉ and R₂₃ is phenyl.

R₂₆ is preferably a direct bond.

n₁, n₂, n₂* and n₄ are preferably a number from 2 to 25, in particular 2 to 20.

n₃ is preferably a number from 1 to 25, in particular 1 to 20 or 2 to 20.

b₁ and b₂ are preferably a number from 2 to 25, in particular 2 to 20.

b₃ and b₄ are preferably a number from 1 to 25, in particluar 1 to 20 or 2 to 20.

b′₅ and b′″₅ are preferably 3 and b″₅ is preferably 2.

As is preferably hydrogen, C₁-C₄alkyl, C₁-C₁₀alkoxy, cyclohexyloxy, allyl, benzyl or acetyl. E₁, E₈, E₁₂, E₁₃, E₁₆, E₁₈, E₂₂, E₂₃, E₂₅ and E₂₉ are preferably hydrogen, C₁-C₄alkyl, C₁-C₁₀alkoxy, cyclohexyloxy, allyl, benzyl or acetyl.

R₆, R₁₃, R₁₆, R₁₈, R₃₀ and R₃₂ are preferably hydrogen, C₁-C₄alkyl, C₁-C₁₀alkoxy, cyclohexyloxy, allyl, benzyl or acetyl.

A₈, E₁, E₈, E₁₂, E₁₃, E₁₆, E₁₈, E₂₂, E₂₃, E₂₅, E₂₉, R₆, R₁₃, R₁₆, R₁₈, R₃₀ and R₃₂ are preferably hydrogen or methyl and E₁ and R₆ additionally are C₁-C₈alkoxy.

The compounds described above as component (III) are essentially known and commercially available. All of them can be prepared by known processes.

The preparation of the compounds of the formulae (A-1), (A-2-a), (A-2-b), (A-3) and (A-4) is disclosed, for example, in U.S. Pat. No. 4,233,412, U.S. Pat. No. 4,340,534, WO-A-98/51,690 and EP-A-1,803.

The preparation of the compounds of the formulae (B-1), (B-2), (B-3), (B-4), (B-5), (B-6), (B-7), (B-8), (B-9) and (B-10) is disclosed, for example, in U.S. Pat. No. 5,679,733, U.S. Pat. No. 3,640,928, U.S. Pat. No. 4,198,334, U.S. Pat. No. 5,204,473, U.S. Pat. No. 4,619,958, U.S. Pat. No. 4,110,306, U.S. Pat. No. 4,110,334, U.S. Pat. No. 4,689,416, U.S. Pat. No. 4,408,051, SU-A-768,175 (Derwent 88-138,751/20), U.S. Pat. No. 5,049,604, U.S. Pat. No. 4,769,457, U.S. Pat. No. 4,356,307, U.S. Pat. No. 4,619,956, U.S. Pat. No. 5,182,390, GB-A-2,269,819, U.S. Pat. No. 4,292,240, U.S. Pat. No. 5,026,849, U.S. Pat. No. 5,071,981, U.S. Pat. No. 4,547,538 and U.S. Pat. No. 4,976,889.

The preparation of the compounds of the formulae (C-1), (C-2), (C-3), (C-4) and (C-5) as well as the product (C-6) is disclosed, for example, in U.S. Pat. No. 4,086,204, U.S. Pat. No. 6,046,304, U.S. Pat. No. 4,331,586, U.S. Pat. No. 4,108,829, U.S. Pat. No. 5,051,458, WO-A-94/12,544 (Derwent 94-177,274/22), DD-A-262,439 (Derwent 89-122,983/17), U.S. Pat. No. 4,857,595, U.S. Pat. No. 4,529,760 and U.S. Pat. No. 4,477,615 and CAS 136,504-96-6.

The product (C-6) can be prepared analogously to known processes, for example by reacting a polyamine of formula (C-6-1) with cyanuric chloride in a molar ratio of from 1:2 to 1:4 in the presence of anhydrous lithium carbonate, sodium carbonate or potassium carbonate in an organic solvent such as 1,2-dichloroethane, toluene, xylene, benzene, dioxane or tert-amyl alcohol at a temperature of from −20° C. to +10° C., preferably from −1000 to +10° C., in particular from 0° C. to +10° C., for from 2 to 8 hours, followed by reaction of the resultant product with a 2,2,6,6-tetramethyl-4-piperidylamine of the formula (C-6-2). The molar ratio of the 2,2,6,6-tetramethyl-4-piperidylamine to polyamine of the formula (C-6-1) employed is for example from 4:1 to 8:1. The quantity of the 2,2,6,6-tetramethyl-4-piperidylamine can be added in one portion or in more than one portion at intervals of a few hours.

The molar ratio of polyamine of the formula (C-6-1) to cyanuric chloride to 2,2,6,6-tetramethyl-4-piperidylamine of the formula (C-6-2) is preferably from 1:3:5 to 1:3:6.

The following example indicates one way of preparing a preferred product (C-6-a).

### EXAMPLE

23.6 g (0.128 mol) of cyanuric chloride, 7.43 g (0.0426 mol) of N,N′-bis[3-aminopropyl]ethylenediamine and 18 g (0.13 mol) of anhydrous potassium carbonate are reacted at 5° C. for 3 hours with stirring in 250 ml of 1,2-dichloroethane. The mixture is warmed at room temperature for a further 4 hours. 27.2 g (0.128 mol) of N-(2,2,6,6-tetramethyl-4-piperidyl)butylamine are added and the resultant mixture is warmed at 60° C. for 2 hours. A further 18 g (0.13 mol) of anhydrous potassium carbonate are added and the mixture is warmed at 60° C. for a further 6 hours. The solvent is removed by distillation under a slight vacuum (200 mbar) and replaced by xylene. 18.2 g (0.085 mol) of N-(2,2,6,6-tetramethyl-4-piperidyl)butylamine and 5.2 g (0.13 mol) of ground sodium hydroxide are added, the mixture is heated at reflux for 2 hours and, for a further 12 hours, the water formed during the reaction is removed by azeotropic distillation. The mixture is filtered. The solution is washed with water and dried over Na₂SO₄. The solvent is evaporated and the residue is dried at 120-130° C. in vacuo (0.1 mbar). The desired product is obtained as a colourless resin.

In general, the product (C-6) can for example be represented by a compound of the formula (C-6-α), (C-6-β) or (C-6-γ). It can also be in the form of a mixture of these three compounds.

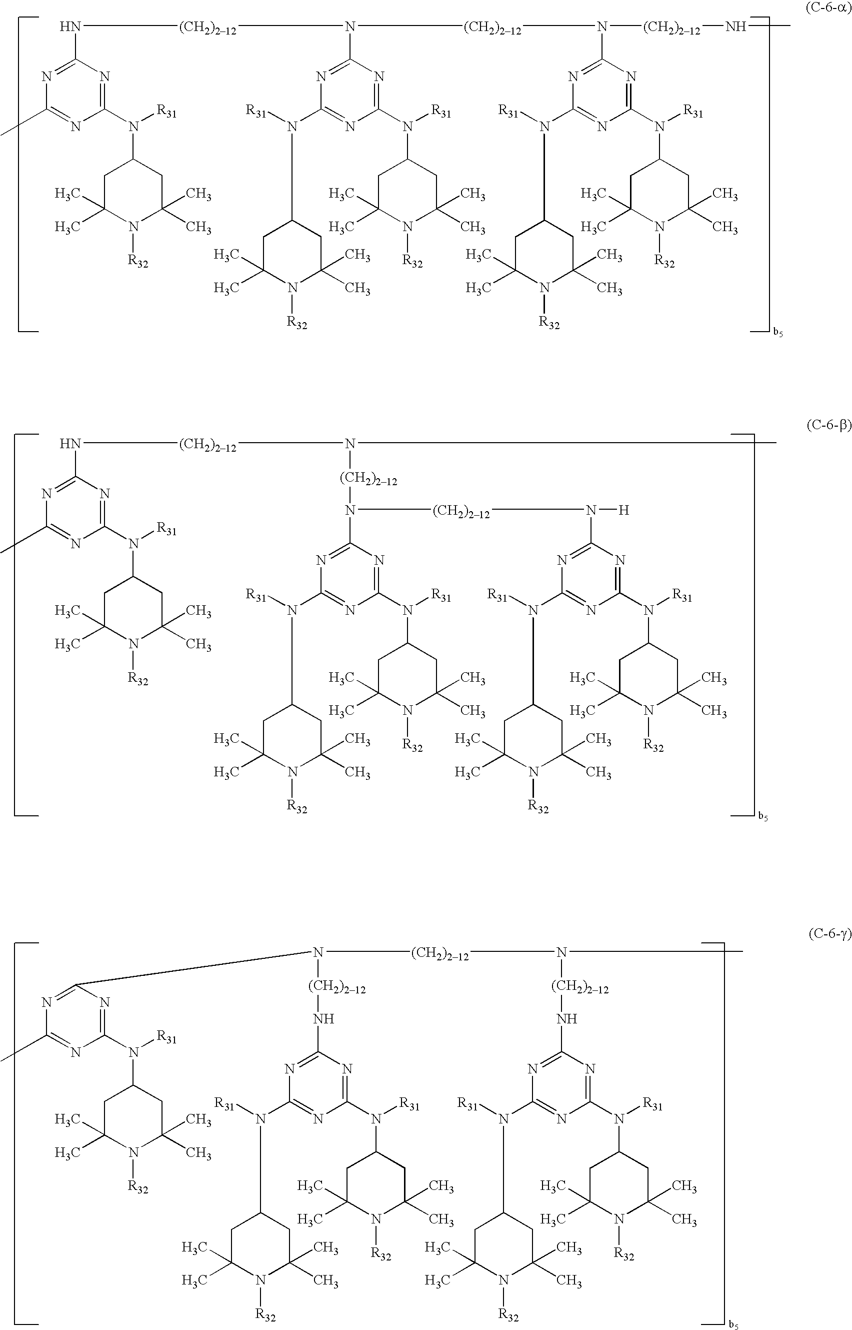

A preferred meaning of the formula (C-6-α) is

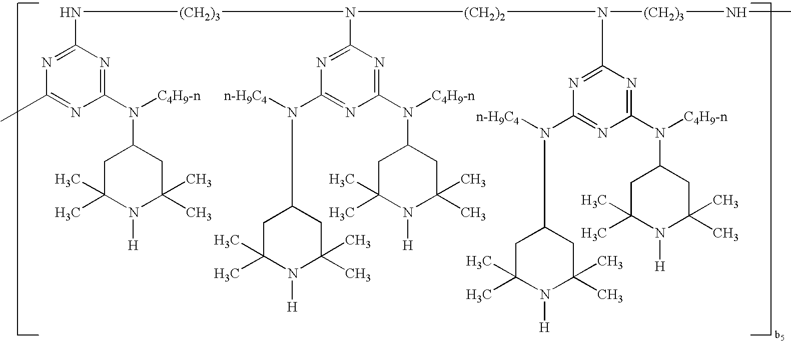

A preferred meaning of the formula (C-6-β) is

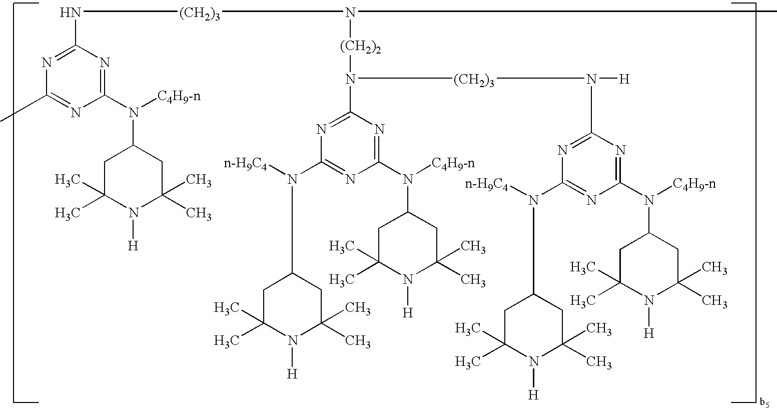

A preferred meaning of the formula (C-6-γ) is

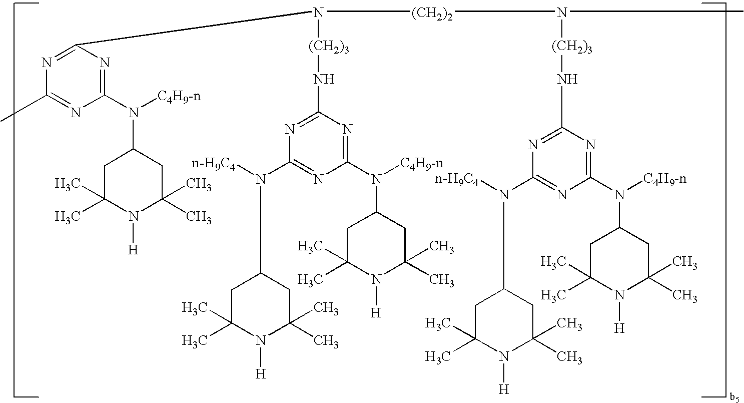

In the above formulae (C-6-α) to (C-6-γ), b₅ is preferably 2 to 20, in particular 2 to 10.

Component (III) is for example TINUVIN 622 (RTM), HOSTAVIN N 30 (RTM), FERRO AM 806 (RTM), DASTIB 845 (RTM), TINUVIN 770 (RTM), TINUVIN 765 (RTM), TINUVIN 144 (RTM), TINUVIN 123 (RTM), ADK STAB LA 52 (RTM), ADK STAB LA 57 (RTM), ADK STAB LA 62 (RTM), ADK STAB LA 67 (RTM), HOSTAVIN N 20 (RTM), HOSTAVIN N 24 (RTM), SANDUVOR 3050 (RTM), DIACETAM 5 (RTM), SUMISORB TM 61 (RTM), UVINUL 4049 (RTM), SANDUVOR PR 31 (RTM), GOODRITE UV 3034 (RTM), GOODRITE UV 3150 (RTM), GOODRITE UV 3159 (RTM), GOODRITE 3110×128 (RTM), UVINUL 4050H (RTM), CHIMASSORB 944 (RTM), CHIMASSORB 2020 (RTM), CYASORB UV 3346 (RTM), CYASORB UV 3529 (RTM), DASTIB 1082 (RTM), CHIMASSORB 119 (RTM), UVASIL 299 (RTM), UVASIL 125 (RTM), UVASIL 2000 (RTM), UVINUL 5050H (RTM), LICHTSCHUTZSTOFF UV 31 (RTM), LUCHEM HA B 18 (RTM), ADK STAB LA 63 (RTM), ADK STAB LA 68 (RTM), UVASORB HA 88 (RTM).

The meanings of the terminal groups which saturate the free valences in the compounds of the formulae (A-1), (A-2-a), (A-2-b), (A-4), (C-1), (C-3), (C-4), (C-5), (C-6-α), (C-6-β) and (C-6-γ) depend on the processes used for their preparation. The terminal groups can also be modified after the preparation of the compounds.

If the compounds of the formula (A-1) are prepared, for example, by reacting a compound of the formula 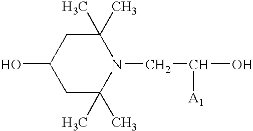
in which A₁ is hydrogen or methyl, with a dicarboxylic acid diester of the formula Y—OOC-A₂-COO—Y, in which Y is, for example, methyl, ethyl or propyl, and A₂ is as defined above, the terminal group bonded to the 2,2,6,6-tetramethyl-4-oxypiperidin-1-yl radical is hydrogen or —CO-A₂-COO—Y, and the terminal group bonded to the diacyl radical is —O—Y or

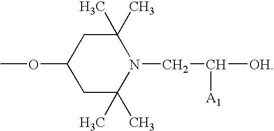

In the compounds of the formula (A-2-a), the terminal group bonded to the nitrogen can be, for example, hydrogen and the terminal group bonded to the 2-hydroxypropylene radical can be, for example, a 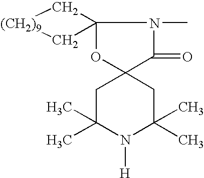
group.

In the compounds of the formula (A-2-b), the terminal group bonded to the dimethylene radical can be, for example, —OH, and the terminal group bonded to the oxygen can be, for example, hydrogen. The terminal groups can also be polyether radicals.

In the compounds of the formula (A-4), the end group bonded to the —CH₂— residue can be, for example, hydrogen and the end group bonded to the —CH(CO₂A₇) residue can be, for example, —CH═CH—COOA₇.

If the compounds of the formula (C-1) are prepared by reacting a compound of the formula 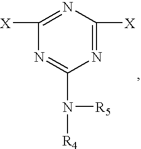
in which X is, for example, halogen, in particular chlorine, and R₄ and R₅ are as defined above, with a compound of the formula 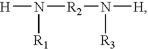
in which R₁, R₂ and R₃ are as defined above, the terminal group bonded to the diamino radical is hydrogen or 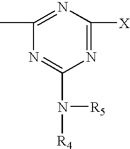
and the terminal group bonded to the triazine radical is X or

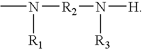

If X is halogen, it is advantageous to replace this, for example, by —OH or an amino group when the reaction is complete. Examples of amino groups which may be mentioned are pyrrolidin-1-yl, morpholino, —NH₂, —N(C₁-C₈)alkyl)₂ and —NR(C₁-C₈alkyl), in which R is hydrogen or a group of the formula (c-I).

The compounds of the formula (C-1) also cover compounds of the formula 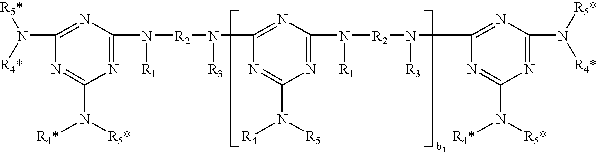
wherein R₁, R₂, R₃, R₄, R₅ and b₁ are as defined above and R₄* has one of the meanings of R₄ and R₅* has one of the meanings of R₅.

One of the particularly preferred compounds of the formula (C-1) is

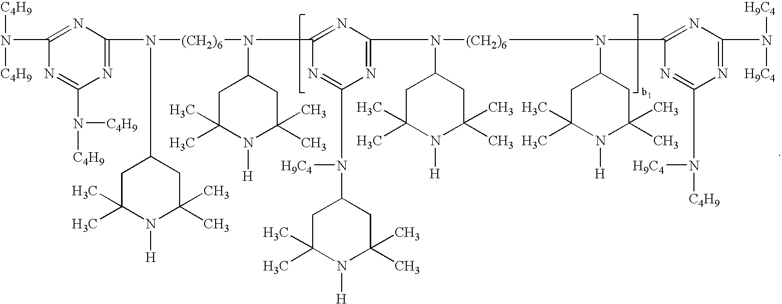

The preparation of this compound is described in Example 10 of U.S. Pat. No. 6,046,304.

In the compounds of the formula (C-3), the terminal group bonded to the silicon atom can be, for example, (R₁₄)₃Si—O—, and the terminal group bonded to the oxygen can be, for example, —Si(R₁₄)₃.

The compounds of the formula (C-3) can also be in the form of cyclic compounds if b₂ is a number from 3 to 10, i.e. the free valences shown in the structural formula then form a direct bond.

In the compounds of the formula (C-4), the terminal group bonded to the 2,5-dioxopyrrolidine ring is, for example, hydrogen, and the terminal group bonded to the —C(R₂₃)(R₂₄)— radical is, for example,

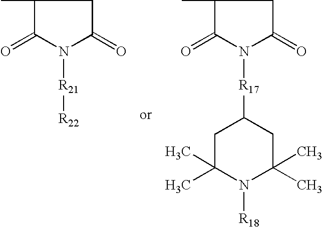

In the compounds of the formula (C-5), the terminal group bonded to the carbonyl radical is, for example, 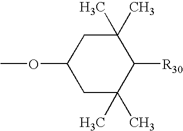
and the terminal group bonded to the oxygen radical is, for example,

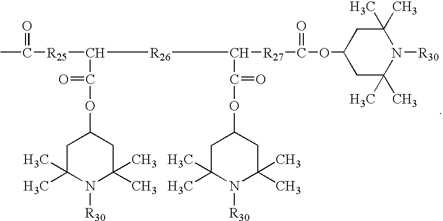

In the compounds of the formulae (C-6-α), (C-6-β) and (C-6-γ), the terminal group bonded to the triazine radical is, for example, Cl or a 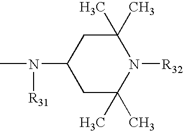
group, and the terminal group bonded to the amino radical is, for example, hydrogen or a 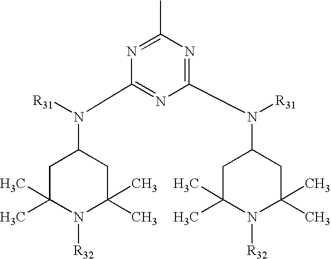
group.

According to a preferred embodiment
A₁ is hydrogen or methyl,
A₂ is a direct bond or C₂-C₆alkylene, and
n, is a number from 2 to 25;
n₂ and n₂* are a number from 2 to 25;
A₃ and A₄ independently of one another are hydrogen or C₁-C₄alkyl, or A₃ and A₄ together form a C₉-C₁₃alkylene group, and
the variables n₃ independently of one another are a number from 1 to 25;
n₄ is a number from 2 to 25,
A₅ and A₆ independently of one another are C₁-C₄alkyl, and
A₇ is C₁-C₄alkyl or a group of the formula (a-I) with the proviso that at least 50% of the radicals A₇ are a group of the formula (a-I);
m₁ is 1, 2 or 4,
if m₁ is 1, E₂ is C₁₂-C₂₀alkyl,
if m₁ is 2, E₂ is C₂-C₁₀alkylene or a group of the formula (b-I),
E₃ is C₁-C₄alkyl,
E₄ is C₀-C₆alkylene, and
E₅ and E₆ independently of one another are C₁-C₄alkyl, and
if m₁ is 4, E₂ is C₄-C₈alkanetetrayl;
two of the radicals E₇ are —COO—(C₁₀-C₁₅alkyl), and
two of the radicals E₇ are a group of the formula (b-II);
E₉ and E₁₀ together form C₉-C₁₃alkylene,
E₁₁ is hydrogen or a group -Z₁-COO-Z₂,
Z₁ is C₂-C₆alkylene, and
Z₂ is C₁₀-C₁₆alkyl;
E₁₄ is hydrogen, and
E₁₅ is C₂-C₆alkylene or C₃-C₅alkylidene;
E₁₇ is C₁₀-C₁₄alkyl;
E₂₄ is C₁-C₄alkoxy;
m₂ is 1, 2 or 3,
when m₂ is 1, E₂₆ is a group 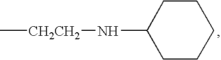
when m₂ is 2, E₂₆ is C₂-C₆alkylene, and
when m₂ is 3, E₂₆ is a group of the formula (b-IV)
the radicals E₂₇ independently of one another are C₂-C₆alkylene, and
the radicals E₂₈ independently of one another are C₁-C₄alkyl or C₅-C₈cycloalkyl; and
E₃₀ is C₂-C₈alkylene;
R₁ and R₃ independently of one another are a group of the formula (c-I),
R₂ is C₂-C₈alkylene,
R₄ and R₅ independently of one another are hydrogen, C₁-C₁₂alkyl, C₅-C₈cycloalkyl or a group of the formula (c-I), or the radicals R₄ and R₅, together with the nitrogen atom to which they are bonded, form a 5- to 10-membered heterocyclic ring, and b₁ is a number from 2 to 25;
R₇ and R₁₁ independently of one another are hydrogen or C₁-C₄alkyl,
R₈, R₉ and R₁₀ independently of one another are C₂-C₄alkylene, and
X₁, X₂, X₃, X₄, X₅, X₆, X₇ and X₈ independently of one another are a group of the formula (c-II),
R₁₂ is hydrogen, C₁-C₄alkyl, C₅-C₈cycloalkyl or a group of the formula (c-I);
R₁₄ is C₁-C₄alkyl,
R₁₅ is C₃-C₈alkylene, and
b₂ is a number from 2 to 25;
R₁₇ and R₂₁ independently of one another are a direct bond or a group —N(X₉)—CO—X₁₀—CO—N(X₁₁)—,
X₉ and X₁₁ independently of one another are hydrogen or C₁-C₄alkyl,
X₁₀ is a direct bond,
R₁₉ and R₂₃ are C₁-C₂₅alkyl or phenyl,
R₂₀ and R₂₄ are hydrogen or C₁-C₄alkyl,
R₂₂ is C₁-C₂₅alkyl or a group of the formula (c-I), and
b₃ is a number from 1 to 25;
R₂₅, R₂₆, R₂₇, R₂₈ and R₂₉ independently of one another are a direct bond or C₁-C₄alkylene, and
b₄ is a number from 1 to 25;
b′₅, b″₅ and b′″₅ independently of one another are a number from 2 to 4, and
R₃₁ is hydrogen, C₁-C₄alkyl, C₅-C₈cycloalkyl, phenyl or benzyl.

A non-agricultural article of interest is one wherein component (III) is one or more sterically hindered amine compounds selected from the group consisting of the compounds of the formulae
(A-1-a), (A-2-a), (A-2-b), (A-3-a), (A-4-a),
(B-1-a), (B-1-b), (B-1-c), (B-1-d), (B-2-a), (B-3-a), (B-3-b), (B-4-a), (B-4-b), (B-5), (B-6-a), (B-7), (B-8-a), (B-9-a), (B-9-b), (B-9-c), (B-10-a),
(C-1-a), (C-1-b), (C-1-c), (C-1-d), (C-2-a), (C-3-a), (C-4-a), (C-4-b), (C-4-c) and (C-5-a) and a product (C-6-a); 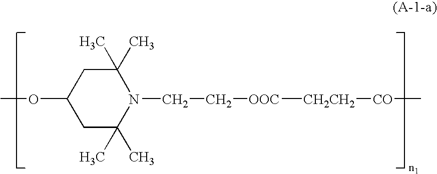
   wherein n, is a number from 2 to 20; 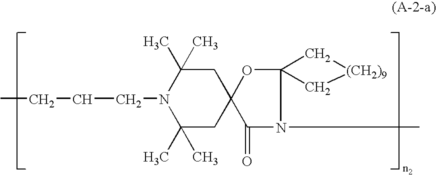 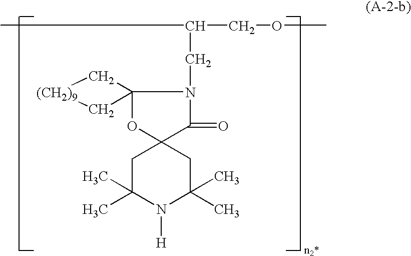
   wherein n₂ and n₂* are a number from 2 to 20; 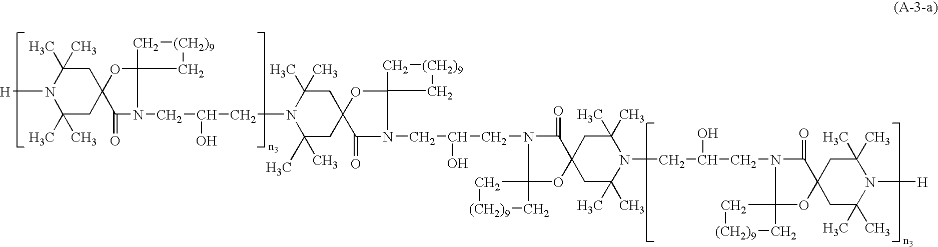
   wherein the variables n₃ independently of one another are a number from 1 to 20; 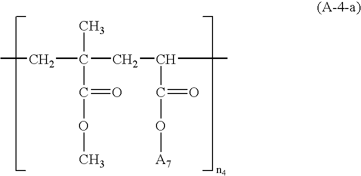
   wherein n₄ is a number from 2 to 20, and
   at least 50% of the radicals A₇ are a group of the formula (a-I) 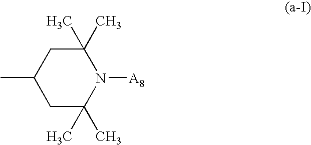
   wherein A₈ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl,
   and the remaining radicals A₇ are ethyl; 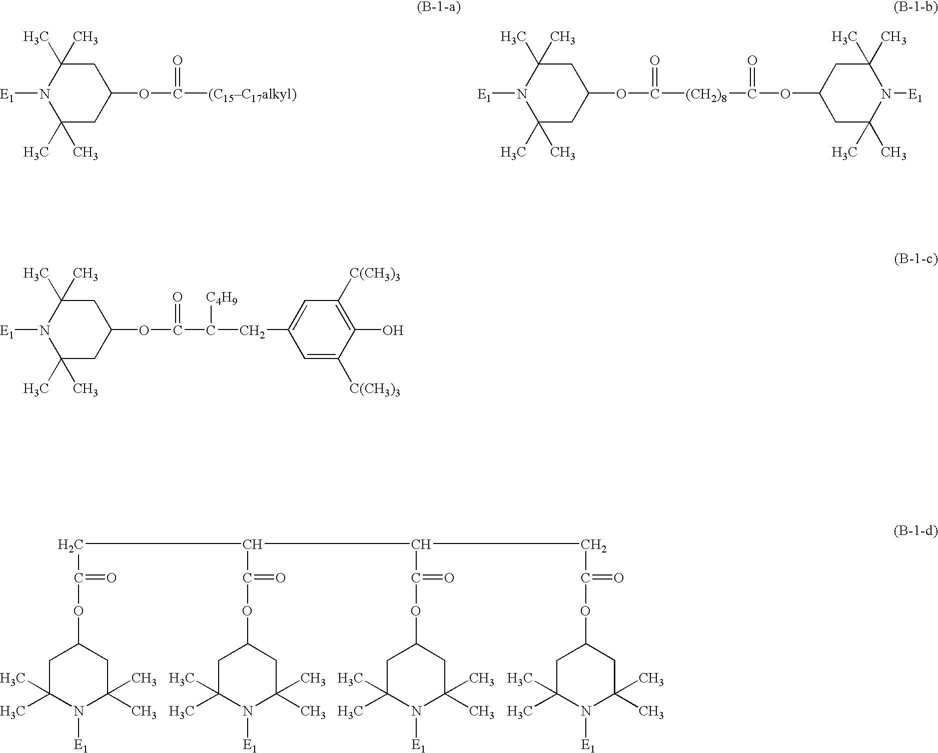
   wherein E₁ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl; 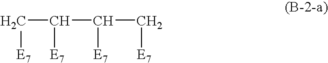
   in which two of the radicals E₇ are —COO—C₁₃H₂₇ and two of the radicals E₇ are 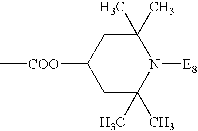
   and E₈ has one of the meanings of E₁; 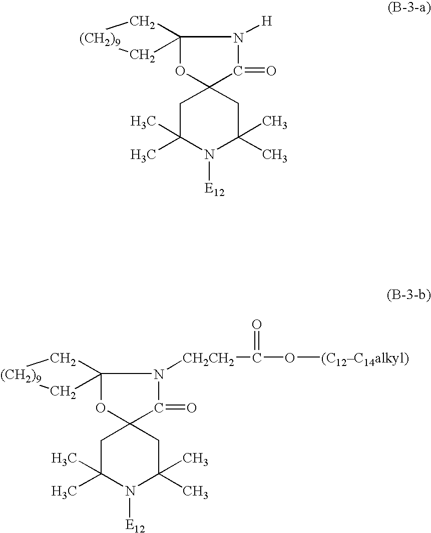
   wherein E₁₂ has one of the meanings of E₁; 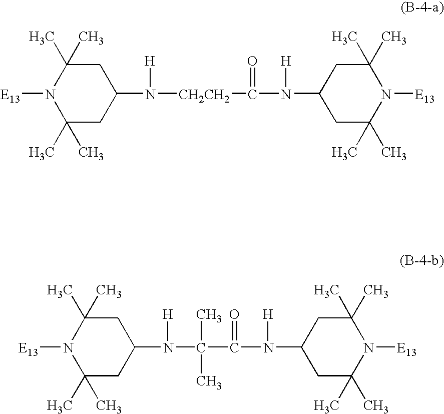
   wherein E₁₃ has one of the meanings of E₁; 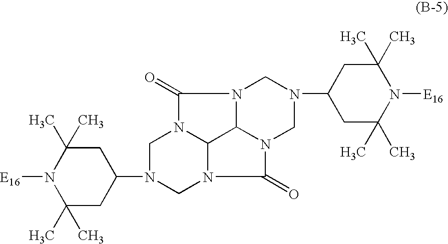
   wherein E₁₆ has one of the meanings of E₁; 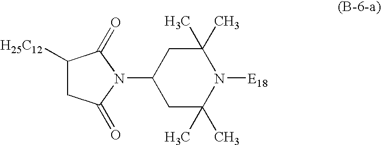
   wherein E₁a has one of the meanings of E₁; 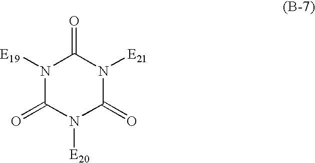
   in which E₁₉, E₂₀ and E₂₁ independently of one another are a group of the formula (b-III) 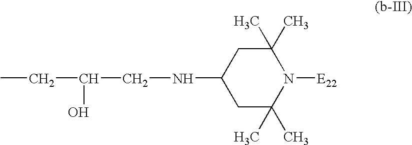
   wherein E₂₂ has one of the meanings of E₁; 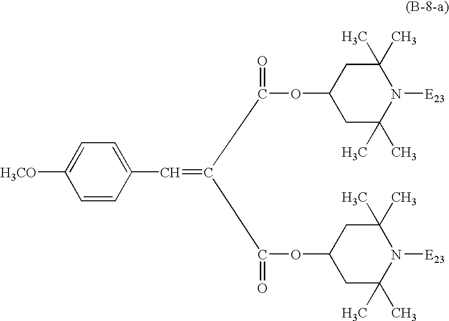
   wherein E₂₃ has one of the meanings of E₁; 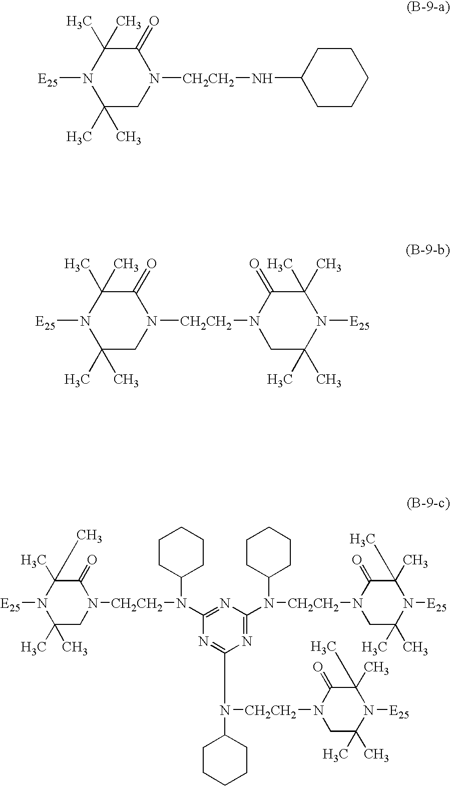
   wherein E₂₅ has one of the meanings of E₁; 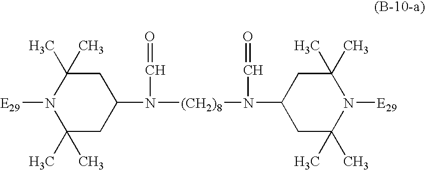
   wherein E₂₉ has one of the meanings of E₁; 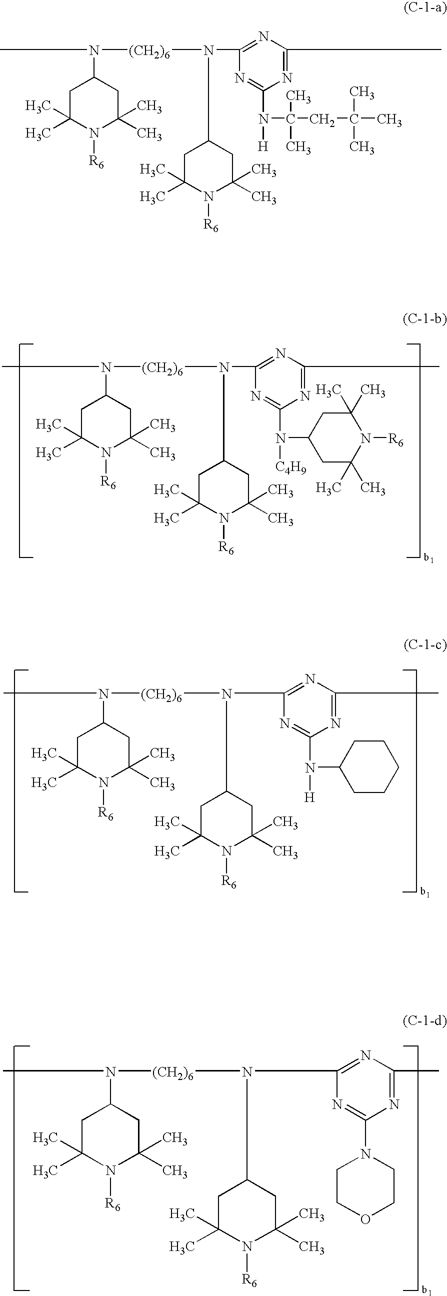
   wherein b, is a number from 2 to 20 and R₆ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₄acyl; 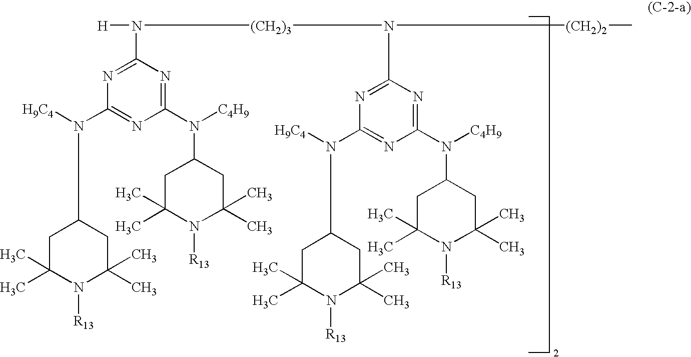
   wherein R₁₃ has one of the meanings of R₆, 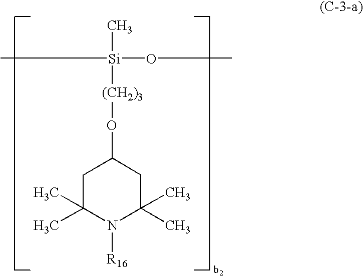
   wherein b₂ is a number from 2 to 20 and R₁₆ has one of the meanings of R₆; 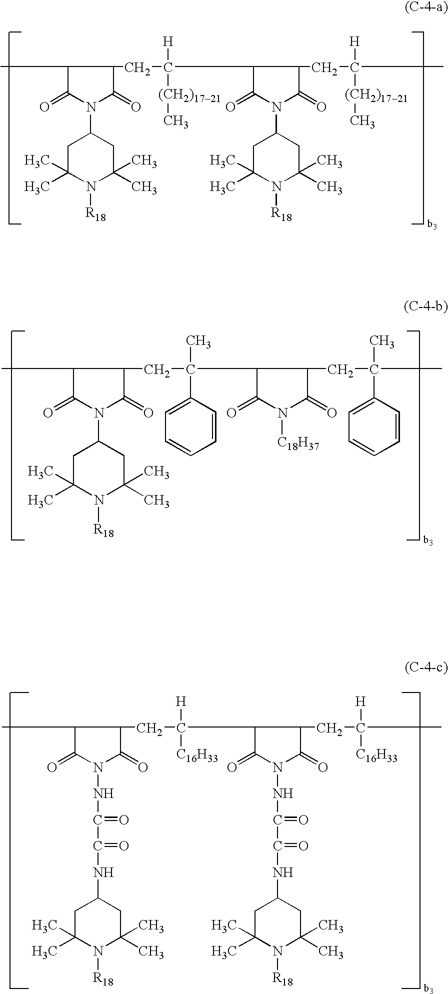
   wherein b₃ is a number from 1 to 20 and R₁₈ has one of the meanings of R₆; 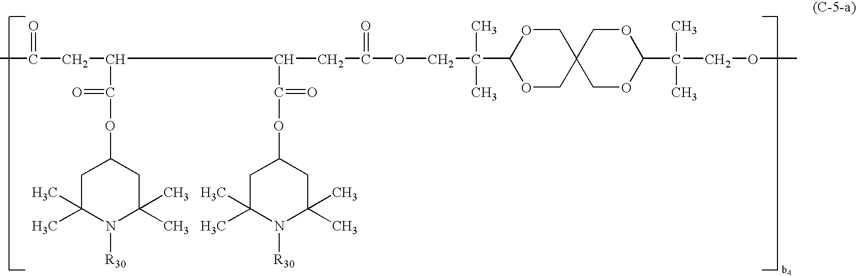
   wherein b₄ is a number from 1 to 20 and R₃₀ has one of the meanings of R₆;
   a product (C-6-a) obtainable by reacting a product, obtained by reaction of a polyamine of the formula (C-6-1-a) with cyanuric chloride, with a compound of the formula (C-6-2-a) 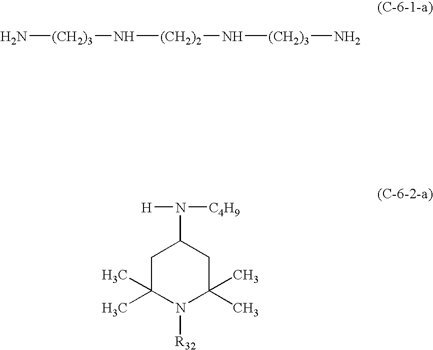
   in which R₃₂ has one of the meanings of R₆.

According to a preferred embodiment component (III) is a compound of the formula
(A-1-a), (A-2-a), (A-2-b),
(B-1-a), (B-1-b), (B-1-c), (B-1-d), (B-2-a), (B-3-a), (B-3-b), (B-4-a), (B-4-b), (B-5), (B-6-a), (B-8-a), (B-9-b), (B-10-a),
(C-1-a), (C-1-b), (C-1-c), (C-1-d), (C-2-a), (C-3-a), (C-4-a) or (C-5-a) or a product (C-6-a).

According to a particular preferred embodiment component (III) is a compound of the formula
(A-1-a), (A-2-a), (A-2-b),
(C-1-a), (C-1-b), (C-1-c), (C-1-d), (C-2-a), (C-3-a), (C-4-a) or (C-5-a) or a product (C-6-a).

A non-agricultural article which is of interest contains as component (III) two different sterically hindered amine compounds selected from the group consisting of the compounds of the formulae
(A-1-a), (A-2-a), (A-2-b), (A-3-a), (A-4-a),
(B-1-a), (B-1-b), (B-1-c), (B-1-d), (B-2-a), (B-1a), (B-3-b), (B-4-a), (B-4-b), (B-5), (B-6-a), (B-7), (B-8-a), (B-9-a), (B-9-b), (B-9-c), (B-10-a),
(C-1-a), (C-1-b), (C-1-c), (C-1-d), (C-2-a), (C-3-a), (C-4-a), (C-4-b), (C-4-c) and (C-5-a) and a product (C-6-a);
   with the proviso that the two different sterically hindered amine compounds are not selected from the same generic formula.

Component (III) is particularly preferred a compound of the formula (A-1-a), or
a compound of the formula (C-1-a) wherein R₆ is hydrogen, or
a combination of a compound of the formula (A-1-a) with a compound of the formula (C-1-a) wherein R₆ is hydrogen, or
a combination of a compound of the formula (A-1-a) with a compound of the formula (C-2-a) wherein R₁₃ is methyl, or
a combination of a compound of the formula (B-1-b) wherein E₁ is hydrogen with a compound of the formula (C-1-a) wherein R₆ is hydrogen.

Component (II) is preferably a C₂-C₂₄carboxylate of Fe, Ce, Co, Mn, Cu or Vd, in particular Ce, Co or Mn.

C₁₀-C₂₀alkanoates of Ce, Co or Mn or C₁₀-C₂₀alkenoates of Ce, Co or Mn are of particular interest.

Examples of component (II) are stearates, oleates, linoleates, linolenates, neodecanoates, behenates, myristates, erucates and naphthenates of Fe, Ce, Co, Mn, Cu or Vd. A particular preferred embodiment relates to stearates of Ce, Co or Mn.

Examples of component (I) are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ d(DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethyleneacrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrenelisoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Component (I) is preferably a synthetic polymer, in particular from one of the above groups. Polyolefins are preferred and polyethylene, polypropylene, a polyethylene copolymer or a polypropylene copolymer are particularly preferred.

According to a further preferred embodiment, component (1) is a polyolefin homo- or copolymer, a starch modified polyolefin, a starch based polymer composite or a biopolymer.

According to another preferred embodiment component (I) is a biopolymer selected from the group consisting of polycaprolactone, polylactic acid, polyglycolic acid, polyhydroxybutyratevalerate, polybutylene succinate, polyvinyl alcohol, polyhydroxyalcanoate and polyethylene adipate.

The non-agricultural article of this invention may contain further one or more conventional additives. Examples are

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(ce-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroauinones and alkylated hydrocuinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocorherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butyl-4-hydroxy-2-methylphenyl)pentane.

1.7. O—, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol propane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-(3-(3-tert-butyl-4-hydroxy-5-methylphenyl)propionyloxy)-1,1-dimethylethyl]-2,4,8,10-tetraoxaspiro[5.5]-undecane.

1.15. Esters of β-(3.5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3.5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tertbutyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-disec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyidiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyidiphenylamines, 2,3-dihydro-3,3-dimethyl-4H-1,4-benzothiazine, phenothiazine, a mixture of mono- and dialkylated tertbutyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetra-methylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilisers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂ COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyidithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetra-methyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-tri-chloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-(2-hydroxy-4-[3-(2-ethylhexyl-1-oxy)-2-hydroxypropyloxy]phenyl)-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl)phosphite (Irgafos®168, Ciba-Geigy), tris(nonylphenyl) phosphite,

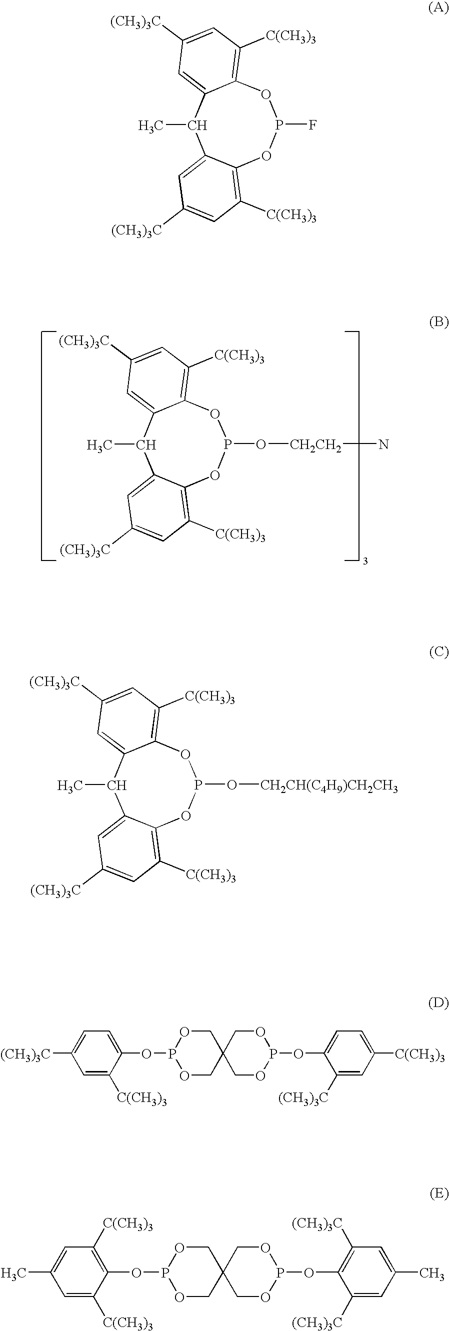

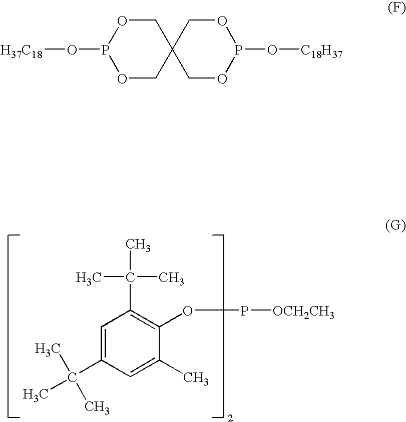

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example N-benzyl-alpha-phenylnitrone, N-ethyl-alpha-methylnitrone, N-octylalpha-heptylnitrone, N-lauryl-alpha-undecylnitrone, N-tetradecyl-alpha-tridecyInitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecyinitrone, N-octadecyl-alpha-hexadecylnitrone, nitrone derived from N,N-dialkylhydroxylamine derived from hydrogenated tallow amine.

7. Thiosynergists, for example dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilisers, for example copper salts in combination with iodides and/or phosphorus compounds and salts of divalent manganese.

10. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one.

A preferred non-agricultural article additionally contains an aliphatic poly hydroxy-carboxyl acid, in particular citric acid.

An aliphatic poly hydroxy-carboxyl acid is in particular an aliphatic acid having either more than one —OH or more than one —COOH group in the organic acid. Examples are the aliphatic, dihydroxy, monocarboxyl acids, such as glyoxylic acid and glyceric acid; the aliphatic, polyhydroxy, monocarboxyl acids, such as erythric acid, arabic acid or mannitic acid; the aliphatic, monohydric, dicarboxyl acids, such as tartronic acid or malic acid; the aliphatic, dihydroxy, dicarboxyl acids, such as tartaric acid; the aliphatic, polyhydroxy, dicarboxyl acids, such as trihydroxyglutaric acid and succharic acid; and the aliphatic, monohydroxy, tricarboxyl acids, such as citric acid.

A further preferred embodiment of this invention relates to a non-agricultural article which contains in addition one or more of the following components
(IV) an antioxidant,
(V) an UV absorber,
(VI) a filler,
(VII) a pigment,
(VIII) an inorganic or organic salt of Ca, Mg, Zn or Al.

Preferred antioxidants (component IV)) are those which are described above under item 1.

Suitable examples of fillers (component (VI)) are those described above under item 12. Preferred fillers are inorganic or synthetic carbonates, nepheline syenite, talc, magnesium hydroxide, aluminum trihydrate, diatomaceous earth, mica, natural or synthetic silica and calcinated clay.

Examples of the UV absorber (component (V)) are a 2-(2′-hydroxyphenyl)benzotriazole, a 2-hydroxybenzophenone, an ester of substituted or unsubstituted benzoic acid, an acrylate, an oxamide, a 2-(2-hydroxyphenyl)-1,3,5-triazine, a monobenzoate of resorcinol or a formamidine.

The 2-(2′-hydroxyphenyl)benzotriazole is e.g. 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, mixture of 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol] or the transesterification product of 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃—]₂ where R=3′-tert-butyl-4′-hydroxy-5′-2H-benzotriazol-2-ylphenyl.

2-(3′,5′-Di-tert-butyl-2′-hydroxyphenyl)-5-chloro-benzotriazole, 2-(3′-tert-butyl-2′-hydroxy-5′-methylphenyl)-5-chloro-benzotriazole and 2-(3′,5′-di-tert-amyl-2′-hydroxyphenyl)-benzotriazole are preferred.

The 2-hydroxybenzophenone is for example the 4-hydroxy, 4-methoxy, 4-octyloxy, 4-decyloxy, 4-dodecyloxy, 4-benzyloxy, 4,2′,4′-trihydroxy or 2′-hydroxy-4,4′-dimethoxy derivatives.

2-Hydroxy-4-octyloxybenzophenone is preferred.

The ester of a substituted or unsubstituted benzoic acid is for example 4-tert-butyl-phenyl salicylate, phenyl salicylate, octylphenyl salicylate, dibenzoyl resorcinol, bis(4-tert-butylbenzoyl) resorcinol, benzoyl resorcinol, 2,4-di-tertbutylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate or 2-methyl-4,6-di-tert-butylphenyl 3,5-di-tert-butyl-4-hydroxybenzoate.

2,4-Di-tert-butylphenyl 3,5-di-tert-butyl-4-hydroxybenzoate and hexadecyl 3,5-di-tert-butyl-4-hydroxybenzoate are preferred.

The acrylate is for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate or N-(β-carbomethoxy-β-cyanovinyl)-2-methylindoline.

The oxamide is for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide or its mixture with 2-ethoxy-2′-ethyl-5,4′-di-tert-butoxanilide or mixtures of ortho- and para-methoxy—disubstituted oxanilides or mixtures of o- and p-ethoxy-disubstituted oxanilides.

The 2-(2-hydroxyphenyl)-1,3,5-triazine is for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine or 2-[2-hydroxy-4-(2-ethylhexyloxy)phenyl]-4,6-bis[4-phenylphenyl]-1,3,5-triazine.

2-(2-Hydroxy-4-octyloxyphenyl)-4,6-bis(2,4-dimethylphenyl)-1,3,5-triazine, 2-(2-hydroxy-4-hexyloxy)phenyl-4,6-diphenyl-1,3,5-triazine and 2-[2-hydroxy-4-(2-ethylhexyloxy)phenyl]-4,6-bis[4-phenylphenyl]-1,3,5-triazine are preferred.

The monobenzoate of resorcinol is for example the compound of the formula

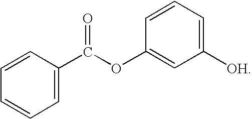

The formamidine is for example the compound of the formula

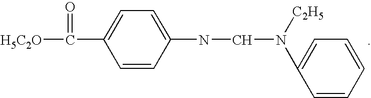

The UV absorber is in particular a 2-(2′-hydroxyphenyl)benzotriazole, a 2-hydroxybenzophenone or a hydroxyphenyltriazine.

The pigment (component (VII)) may be an inorganic or organic pigment.

Examples of inorganic pigments are titanium dioxide, zinc oxide, carbon black, cadmium sulfide, cadmium selenide, chromium oxide, iron oxide, lead oxide and so on.

Examples of organic pigments are azo pigments, anthraquinones, phthalocyanines, tetrachloroisoindolinones, quinacridones, isoindolines, perylenes, pyrrolopyrroles (such as Pigment Red 254) and so on.

All pigments described in “Gächter/Muller: Plastics Additives Handbook, 3rd Edition, Hanser Publishers, Munich Vienna New York”, page 647 to 659, point 11.2.1.1 to 11.2.4.2 can be used as component (VII).

Particularly preferred pigments are titanium dioxide or carbon black, optionally in combination with an organic pigment.

Examples of such organic pigments are:
C.I. (Colour Index) Pigment Yellow 93, C.I. Pigment Yellow 95, C.I. Pigment Yellow 138, C.I. Pigment Yellow 139, C.I. Pigment Yellow 155, C.I. Pigment Yellow 162, C.I. Pigment Yellow 168, C.I. Pigment Yellow 180, C.I. Pigment Yellow 183, C.I. Pigment Red 44, C.I. Pigment Red 170, C.I. Pigment Red 202, C.I. Pigment Red 214, C.I. Pigment Red 254, C.I. Pigment Red 264, C.I. Pigment Red 272, C.I. Pigment Red 48:2, C.I. Pigment Red 48:3, C.I. Pigment Red 53:1, C.I. Pigment Red 57:1, C.I. Pigment Green 7, C.I. Pigment Blue 15:1, C.I. Pigment Blue 15:3 and C.I. Pigment Violet 19.

The organic salt of calcium, magnesium, zinc or aluminum defined in component (VII) is preferably a compound of the formula MeL₂, in which Me is calcium, magnesium or zinc, or a compound of the formula AlL₃. L is an anion of an organic acid or of an enol. The organic acid can, for example, be a sulfonic acid, sulfinic acid, phosphonic acid or phosphinic acid, but is preferably a carboxylic acid. The acid can be aliphatic, aromatic, araliphatic or cycloaliphatic; it can be linear or branched; it can be substituted by hydroxyl or alkoxy groups; it can be saturated or unsaturated and it preferably contains 1 to 24 carbon atoms.

Examples of carboxylic acids of this type are formic, acetic, propionic, butyric, isobutyric, caprioic, 2-ethylcaproic, caprylic, capric, lauric, palmitic, stearic, behenic, oleic, lactic, ricinoleic, 2-ethoxypropionic, benzoic, salicylic, 4-butylbenzoic, toluic, 4-dodecylbenzoic, phenylacetic, naphthylacetic, cyclohexanecarboxylic, 4-butylcyclohexanecarboxylic or cyclohexylacetic acid. The carboxylic acid can also be a technical mixture of carboxylic acids, for example technical mixtures of fatty acids or mixtures of alkylated benzoic acids.

Examples of organic acids containing sulfur or phosphorus are methanesulfonic, ethanesulfonic, α,α-dimethylethanesulfonic, n-butanesulfonic, n-dodecanesulfonic, benzenesulfonic, toluenesulfonic, 4-nonylbenzenesulfonic, 4-dodecylbenzenesulfonic or cyclohexanesulfonic acid, dodecanesulfinic, benzenesulfinic or naphthalenesulfinic acid, butylphosphonic acid, phenylphosphonic acid, monomethyl or monoethyl phenylphosphonate, monobutyl benzylphosphonate, dibutylphosphinic acid or diphenylphosphinic acid.

If L is an enolate anion, it is preferably an anion of a β-dicarbonyl compound or of an o-acylphenol. Examples of β-dicarbonyl compounds are acetylacetone, benzoylacetone, dibenzoylmethane, ethyl acetoacetate, butyl acetoacetate, lauryl acetoacetate or α-acetylcyclohexanone. Examples of o-acylphenols are 2-acetylphenol, 2-butyroylphenol, 2-acetyl-1-naphthol, 2-benzoylphenol or salicylaldehyde. The enolate is preferably the anion of a β-dicarbonyl compound having 5 to 20 carbon atoms.

Organic salts of zinc or magnesium are preferably an acetylacetonate or an aliphatic monocarboxylate having, for example, 1 to 24 carbon atoms. Magnesium acetate, laurate and stearate, zinc formate, acetate, oenanthate, laurate and stearate as well as zinc acetylacetonate and magnesium acetylacetonate are some of the particular preferred examples.

Zinc stearate, magnesium stearate, zinc acetylacetonate, magnesium acetylacetonate, zinc acetate and magnesium acetate are of special interest.

The inorganic salt of zinc, magnesium or aluminum is for example a carbonate containing compound such as
Zn-hydroxide-carbonate, Mg-hydroxide-carbonate, dolomite, e.g a Ca/Mg carbonate such as Microdol Super (RTM) from Micro Minerals (RTM); or
a natural or synthetic hydrotalcite.

The natural hydrotalcite is held to possess a structure MgrAl₂(OH)₁₆CO₃.4H₂O.

A typical empirical formula of a synthetic hydrotalcite is
Al₂Mg_{4.35}OH_{11.36}CO_{3(1.67)}·x H₂O.

Examples of the synthetic product include:
Mg_{0.7}Al_{0.3}(OH)₂(CO₃)_{0.15}·0.54H₂O,
Mg_{4.5}Al₂(OH)₁₃CO₃·3.5H₂O, or
Mg_{4.2}Al(OH)_{12.4}CO₃.

Preferred synthetic hydrotalcites are L-55R II (RTM) from REHEIS (RTM) as well as ZHT-4A (RTM) and DHT-4A (RTM) from Kyowa Chemical Industry Co (RTM).

Component (VII) can also be a mixture of two different Mg- and/or Zn-compounds, for example
Mg-stearate and hydrotalcite (DHT-4A (RTM)),
Zn-stearate and hydrotalcite (DHT-4A (RTM)),
Mg-acetylacetonate and hydrotalcite (DHT-4A (RTM)),
Mg-oxide and hydrotalcite (DHT-4A (RTM)),
Mg-hydroxide and hydrotalcite (DHT-4A (RTM)),
Zn-hydroxide-carbonate and Mg-stearate,
Zn-hydroxide-carbonate and Zn-stearate,
Zn-hydroxide-carbonate and Mg-acetylacetonate,
Zn-hydroxide-carbonate and Mg-oxide,
Zn-hydroxide-carbonate and Zn-oxide,
Zn-hydroxide-carbonate and Mg-hydroxide,
hydrotalcite (REHEIS(RTM)) and Mg-stearate,
hydrotalcite (REHEIS(RTM)) and Zn-stearate,
hydrotalcite (REHEIS(RTM)) and Mg-oxide,
dolomite (Microdol Super(RTM)) and Zn-stearate,
dolomite (Microdol Super(RTM)) and Mg-stearate,
dolomite (Microdol Super(RTM)) and Zn-oxide,
dolomite (Microdol Super(RTM)) and Mg-hydroxide,
Mg-stearate and Zn-stearate,
Mg-stearate and Zn-acetylacetonate,
Mg-stearate and Mg-oxide,
Mg-stearate and Zn-oxide,
Mg-stearate and Mg-hydroxide,
Zn-stearate and Mg-acetate,
Zn-stearate and Mg-oxide,
Zn-stearate and Mg-hydroxide,
Mg-acetylacetonate and Zn-acetylacetonate,
Mg-acetylacetonate and Mg-oxide,
Mg-acetylacetonate and Zn-oxide,
Mg-acetylacetonate and Mg-hydroxide,
Zn-acetylacetonate and Mg-oxide,
Zn-acetylacetonate and Zn-oxide, or
Mg-oxide and Zn-oxide.

In this case, the two different compounds of component (VII) may be present in a weight ratio of 1:10 to 10:1.

According to a preferred embodiment of this invention component (VII) is selected from the group consisting of Mg carboxylates, Zn carboxylates, Al carboxylates, Mg oxides, Zn oxides, Al oxides, Mg hydroxides, Zn hydroxides, Al hydroxides, Mg carbonates, Zn carbonates or Al carbonates.

Preferred examples of component (VII) as an organic salt of Ca are carboxylates such as Ca-stearate, Ca-laurate, Ca-lactate and Ca-stearoyl-lactate.

Examples of component (VII) as an inorganic salt of Ca are CaO, Ca(OH)₂, CaCO₃, CaCl₂, CaF₂, Ca₃(PO₄)₂, CaHPO₄, Ca(PO₃)₂, Ca₂P₂O₇, CaSO₄ and CaSiO₃.

According to another preferred embodiment of this invention component (VII) is a Ca carboxylate, a Mg carboxylate, a Zn carboxylate or a hydrotalcite.

Components (II) and (III) and optionally components (IV) to (VIII) may be added to the organic polymer either individually or mixed with one another.

Components (II) and (III) and optionally components (IV) to (VIII) are present in the organic polymer in an amount suitable to obtain a sufficient weathering resistance and to initiate a controlled degradation at a desired moment.

The possibility of lifetime control is fundamental for non-agricultural articles. The article has to keep its properties and its performance during the service and degradation has to take place when the function of the article is finished. Service lifetimes can vary dramatically.

The main components being present in the organic polymer are one or more prodegradant additives (component (II)) and one or more stabilizers (components (III) to (VIII)). By appropriately dosing the amount of prodegradant and the amount of stabilizer, the required service periods and time to disappearance can be obtained.

Component (II) may be present in the organic polymer in an amount of, for example, 0.005 to 10% or 0.005 to 5%, preferably 0.005 to 1%, in particular 0.03 to 0.4%, relative to the weight of the organic polymer.

Component (III) may be present in the organic polymer in an amount of, for example 0.01 to 20% or 0.01 to 10% or 0.01 to 5%, preferably 0.01 to 1.5%, in particular 0.05 to 1.2%, relative to the weight of the organic polymer.

Component (IV) may be present in the organic polymer in an amount of preferably 0.005 to 1%, in particular 0.01 to 0.3%, relative to the weight of the organic polymer.

Component (V) may be present in the organic polymer in an amount of preferably 0.01 to 5%, in particular 0.1 to 2%, relative to the weight of the organic polymer.

Component (VI) may be present in the organic polymer in an amount of preferably 0.05 to 80%, in particular 0.5 to 70%, relative to the weight of the organic polymer.

Component (VII) may be present in the organic polymer in an amount of preferably 0.05 to 40%, in particular 0.5 to 30%, relative to the weight of the organic polymer.

Component (VIII) may be present in the organic polymer in an amount of preferably 0.005 to 5%, in particular 0.05 to 1%, relative to the weight of the organic polymer.

The total amount of the components (III) to (VIII) being present in the organic polymer is preferably 0.15 to 90%, in particular 1.2 to 80%, relative to the weight of the organic polymer.

The weight ratio of the components (II):(III) may be for example 0.0003:1 to 1000:1 or 0.003:1 to 100:1, in particular 0.025:1 to 8:1.

The weight ratio of the components (II):(IV) may be for example 0.005:1 to 200:1, in particular 0.1:1 to 40:1.

The weight ratio of the components (II):(V) may be for example 0.001:1 to 100:1, in particular 0.015:1 to 4:1.

The weight ratio of the components (II):(VI) may be for example 0.0001:1 to 20:1, in particular 0.0004:1 to 1.0:1.

The weight ratio of the components (II):(VII) may be for example 0.001:1 to 200:1, in particular 0.015:1 to 8:1.

The weight ratio of the components (II):(VIII) may be for example 0.001:1 to 200:1, in particular 0.015:1 to 8:1.

The above components can be incorporated into the organic polymer to be stabilized in a controlled form by known methods, for example before or during shaping or by applying the dissolved or dispersed compounds to the organic polymer, if necessary with subsequent evaporation of the solvent. The components can be added to the organic polymer in the form of a powder, granules or a masterbatch, which contains these components in, for example, a concentration of from 2.5 to 25% by weight.

If desired, the components (II) and (III) and optionally (IV) to (VIII) can be blended with each other before incorporation into the organic polymer. They can be added to the polymer before or during the polymerization or before the crosslinking.

The main components of the present additive system are a prodegradant additive (component (II)) and a weathering stabilizer (component (III)). By appropriately dosing the amount of the prodegradant and the amount of the weathering stabilizer, the required service periods and time to degradation and disappearance can be obtained. Examples of typical life times of non-agricultural articles are 10 to 180 days, lifes up to 24 months can also be required and achieved.

Thus, a further preferred embodiment of the present invention is a non-agricultural article containing the components (I), (II) and (III) as defined above and having a life time of 10 to 720 days.

The example below illustrates the invention in greater detail. All percentages and parts are by weight, unless stated otherwise.

### Example 1

Each compound of the list reported below is mixed via master batch, in a slow mixer, with low density polyethylene (LDPE) pellets (Riblene FF 29 (RTM), supplied by Polimeri Europa(RTM); characterized by a density of 0.921 g/cm³ and a melt flow index of 0.60 at 190° C. and 2.16 Kg), and with linear low density polyethylene (LLDPE) pellets (Clearflex FG308 (RTM), supplied by Polimeri Europa (RTM); characterized by a density of 0.924 g/cm³ and a melt flow index of 0.97 at 190° C. and 2.16 Kg). The ratio LDPE/LLDPE is 1:4.

The mixture is blown at 210° C. and films of 12 and 25 microns thickness are obtained.

The films are exposed outdoors in Pontecchio Marconi (Bologna, Italy). Total irradiation in the location is 110 Klys/year.

During the exposure, the films are periodically checked visually and the time to start of degradation (fessuration) and to embrittlement (=very fragile film=end of the life time) is registered.

The results are indicated in Tables 1 to 4.

TABLE 1
Films without pigment, 25 microns thick.

| | 1:1 Mixture of | | | Days to |
|---|---|---|---|---|
| Cobalt | Stabilizer (A-1-a) and | Stabilizer | Days to | embrittle- |
| Stearate % | Stabilizer (C-1-a-1) % | (A-1-a) % | fessuration | ment |
| Without | Without | Without | 92 | 350 |
| 0.13 | 0.05 | Without | 39 | 67 |
| 0.13 | Without | 0.2 | 52 | 108 |

TABLE 2
Films without pigment, 12 microns thick.

| | 1:1 Mixture of | | |
|---|---|---|---|
| Cobalt Stearate | Stabilizer (A-1-a) and | Days to | Days to |
| % | Stabilizer (C-1-a-1) % | fessuration | embrittlement |
| 0.13 | 0.05 | 43 | 65 |
| 0.13 | 0.2 | 43 | 128 |

TABLE 3
Films with 3% of carbon black, 25 microns thick.

| | 1:1 Mixture of | | |
|---|---|---|---|
| Cobalt Stearate | Stabilizer (A-1-a) and | Days to | Days to |
| % | Stabilizer (C-1-a-1) % | fessuration | embrittlement |
| Without | Without | 120 | 410 |
| 0.13 | 0.6 | 57 | 79 |

TABLE 4
Films with 3% of carbon black, 12 microns thick.

| | 1:1 Mixture of | | |
|---|---|---|---|
| Cobalt Stearate | Stabilizer (A-1-a) and | Days to | Days to |
| % | Stabilizer (C-1-a-1) % | fessuration | embrittlement |
| 0.13 | 0.2 | 36 | 57 |
| 0.13 | 0.6 | 53 | 75 |

Stabilizer (A-1-a):
TINUVIN 622 (RTM) 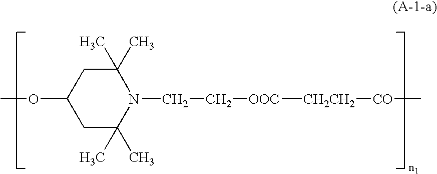
wherein n₁ is a number from 2 to 20.
Stabilizer (C-1-a-1):
CHIMASSORB 944 (RTM) 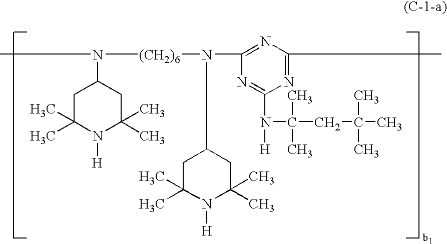
wherein b₁ is a number from 2 to 20.

1. A non-agricultural article comprising the components
(I) an organic polymer,
(II) an organic salt of Fe, Ce, Co, Mn, Cu or Vd, and
(III) one or more sterically hindered amine compounds selected from the group consisting of a compound of the formula (A-1) 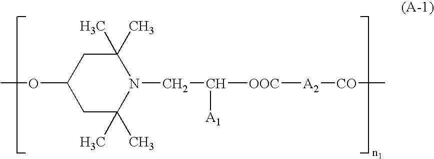
wherein
A₁ is hydrogen or C₁-C₄alkyl,
A₂ is a direct bond or C₁-C₁₀alkylene, and
n, is a number from 2 to 50;
at least one compound of the formulae (A-2-a) and (A-2-b) 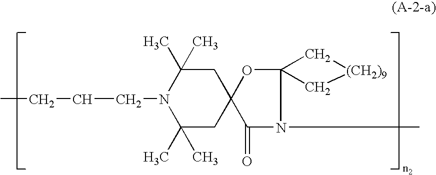 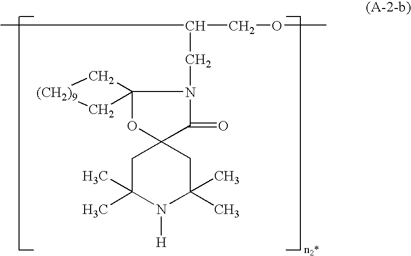
wherein
n₂ and n₂* are a number from 2 to 50;
a compound of the formula (A-3) 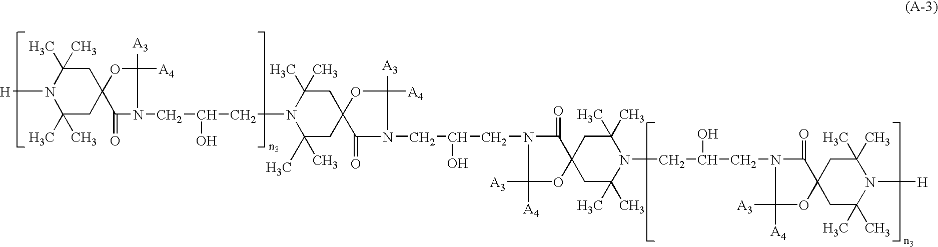
wherein
A₃ and A₄ independently of one another are hydrogen or C₁-C₈alkyl, or A₃ and A₄ together form a C₂-C₁₄alkylene group, and
the variables n₃ independently of one another are a number from 1 to 50;
a compound of the formula (A-4) 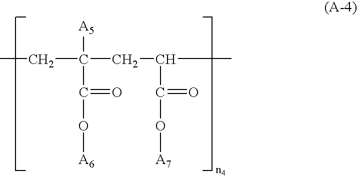
wherein
n₄ is a number from 2 to 50,
A₅ is hydrogen or C₁-C₄alkyl,
the radicals Ar and A₇ independently of one another are C₁-C₄alkyl or a group of the formula (a-I) 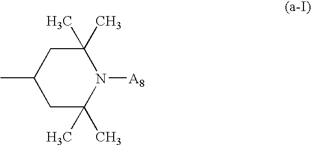
wherein A₈ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl,
with the proviso that at least 50% of the radicals A₇ are a group of the formula (a-I);
a compound of the formula (B-1) 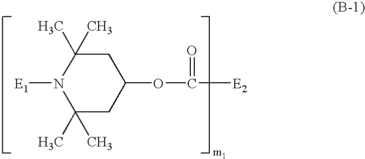
in which
E₁ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl,
m, is 1, 2 or 4,
if m₁ is 1, E₂ is C₁-C₂₅alkyl,
if m₁ is 2, E₂ is C₁-C₁₄alkylene or a group of the formula (b-I) 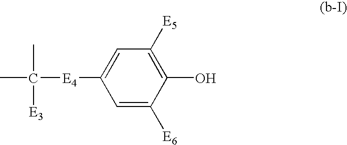
wherein E₃ is C₁-C₁₀alkyl or C₂-C₁₀alkenyl, E₄ is C₁-C₁₀alkylene, and
E₅ and E₆ independently of one another are C₁-C₄alkyl, cyclohexyl or methylcyclohexyl, and
if m₁ is 4, E₂ is C₄-C₁₀alkanetetrayl;
a compound of the formula (B-2) 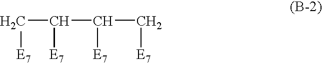
in which
two of the radicals E₇ are —COO—(C₁-C₂₀alkyl), and
two of the radicals E₇ are a group of the formula (b-II) 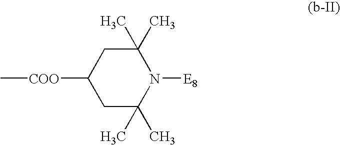
with E₈ having one of the meanings of E₁;
a compound of the formula (B-3) 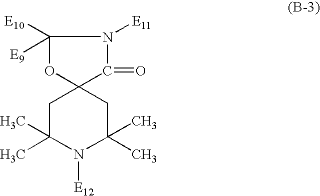
in which
E₉ and E₁₀ together form C₂-C₁₄alkylene,
E₁₁ is hydrogen or a group -Z₁-COO-Z₂,
Z₁ is C₂-C₁₄alkylene, and
Z₂ is C₁-C₂₄alkyl, and
E₁₂ has one of the meanings of E₁;
a compound of the formula (B-4) 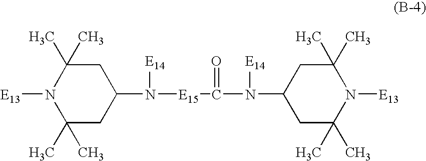
wherein
the radicals E₁₃ independently of one another have one of the meanings of E₁,
the radicals E₁₄ independently of one another are hydrogen or C₁-C₁₂alkyl, and
E₁₅ is C₁-C₁₀alkylene or C₃-C₁₀alkylidene;
a compound of the formula (B-5) 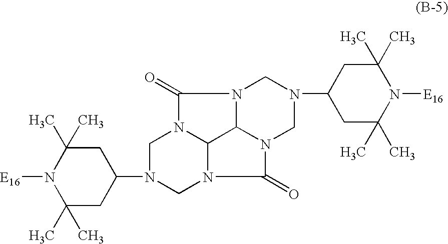
wherein
the radicals E₁₆ independently of one another have one of the meanings of E₁;
a compound of the formula (B-6) 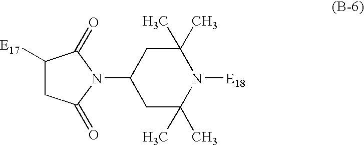
in which
E₁₇ is C₁-C₂₄alkyl, and
E₁₈ has one of the meanings of E₁;
a compound of the formula (B-7) 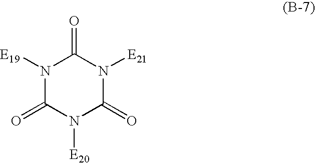
in which
E₁₉, E₂₀ and E₂₁ independently of one another are a group of the formula (b-III) 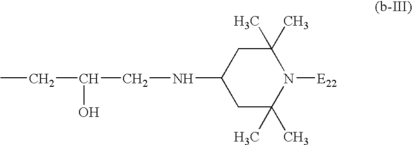
wherein E₂₂ has one of the meanings of E₁;
a compound of the formula (B-8) 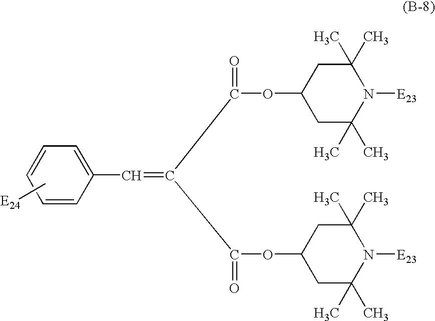
wherein
the radicals E₂₃ independently of one another have one of the meanings of E₁, and E₂₄ is hydrogen, C₁-C₁₂alkyl or C₁-C₁₂alkoxy;
a compound of the formula (B-9) 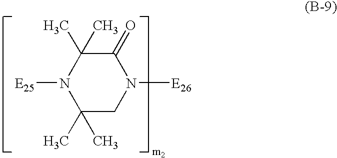
wherein
m₂ is 1, 2 or 3,
E₂₅ has one of the meanings of E₁, and
when m₂ is 1, E₂₆ is a group 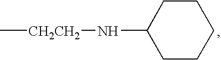
when m₂ is 2, E₂₆ is C₂-C₂₂alkylene, and
when m₂ is 3, E₂₆ is a group of the formula (b-IV) 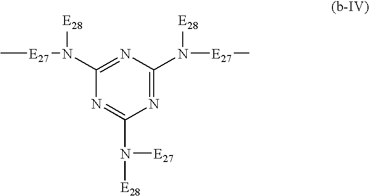
wherein the radicals E₂₇ independently of one another are C₂-C₁₂alkylene, and the radicals E₂₈ independently of one another are C₁-C₁₂alkyl or C₅-C₁₂cycloalkyl;
a compound of the formula (B-10) 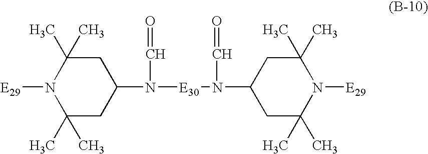
wherein
the radicals E₂₉ independently of one another have one of the meanings of E₁, and E₃₀ is C₂-C₂₂alkylene, C₅-C₇cycloalkylene, C₁-C₄alkylenedi(C₅-C₇cycloalkylene), phenylene or phenylenedi(C₁-C₄alkylene);
a compound of the formula (C-1) 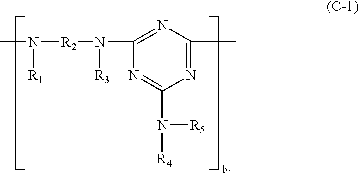
in which
R₁, R₃, R₄ and R₅ independently of one another are hydrogen, C₁-C₁₂alkyl, C₅-C₁₂cycloalkyl, C₁-C₄-alkyl-substituted C₅-C₁₂cycloalkyl, phenyl, phenyl which is substituted by —OH and/or C₁-C₁₀alkyl;
C₇-C₉phenylalkyl, C₇-C₉phenylalkyl which is substituted on the phenyl radical by —OH and/or C₅-C₁₀alkyl; or a group of the formula (c-I) 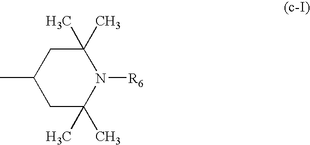
R₂ is C₂-C₁₈alkylene, C₅-C₇cycloalkylene or C₁-C₄alkylenedi(C₅-C₇cycloalkylene), or
the radicals R₁, R₂ and R₃, together with the nitrogen atoms to which they are bonded, perform a 5- to 10-membered heterocyclic ring, or
R₄ and R₅, together with the nitrogen atom to which they are bonded, form a 5- to 10-membered heterocyclic ring,
R₆ is hydrogen, C₁-C₈alkyl, —O, —OH, —CH₂CN, C₁-C₁₈alkoxy, C₂-C₁₈alkoxy substituted by —OH; C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl, and
b₁ is a number from 2 to 50,
with the proviso that at least one of the radicals R₁, R₃, R₄ and R₅ is a group of the formula (c-I);
a compound of the formula (C-2) 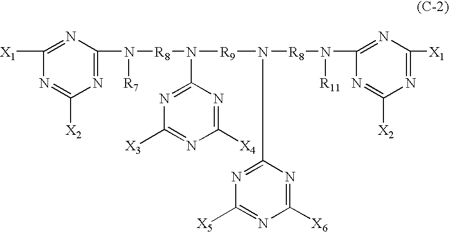
wherein
R₇ and R₁₁ independently of one another are hydrogen or C₁-C₁₂alkyl,
R₈, R₉ and R₁₀ independently of one another are C₂-C₁₀alkylene, and
X₁, X₂. X₃, X₄, X₅, X₆, X₇ and X₈ independently of one another are a group of the formula (c-II), 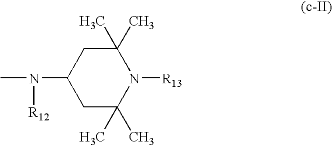
in which R₁₂ is hydrogen, C₁-C₁₂alkyl, C₅-C₁₂cycloalkyl, C₁-C₄alkyl-substituted
C₅-C₁₂cycloalkyl, phenyl, —OH— and/or C₁-C₁₀alkyl-substituted phenyl, C₇-C₉phenylalkyl,
C₇-C₉phenylalkyl which is substituted on the phenyl radical by —OH and/or C₁-C₁₀alkyl; or a group of the formula (c-I) as defined above, and
R₁₃ has one of the meanings of R₆;
a compound of the formula (C-3) 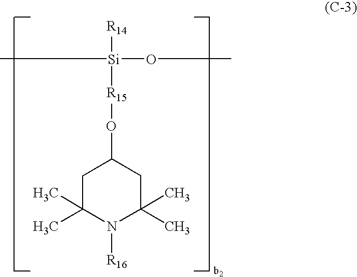
in which
R₁₄ is C₁-C₁₀alkyl, C₅-C₁₂cycloalkyl, C₁-C₄alkyl-substituted C₅-C₁₂cycloalkyl, phenyl or C₁-C₁₀alkyl-substituted phenyl,
R₁₅ is C₃-C₁₀alkylene,
R₁₆ has one of the meanings of R₆, and
b₂ is a number from 2 to 50;
a compound of the formula (C-4) 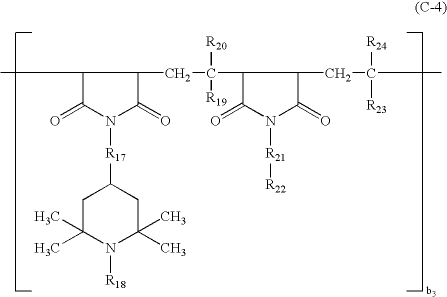
in which
R₁₇ and R₂₁ independently of one another are a direct bond or a —N(X₉)—CO—X₁₀—CO—N(X₁₁)— group, where X₉ and X₁₁ independently of one another are hydrogen, C₁-C₈alkyl, C₅-C₁₂cycloalkyl, phenyl, C₇-C₉phenylalkyl or a group of the formula (c-I),
X₁₀ is a direct bond or C₁-C₄alkylene,
R₁₈ has one of the meanings of R₆,
R₁₉, R₂₀, R₂₃ and R₂₄ independently of one another are hydrogen, C₁-C₃₀alkyl, C₅-C₁₂cycloalkyl or phenyl,
R₂₂ is hydrogen, C₁-C₃₀alkyl, C₅-C₁₂cycloalkyl, phenyl, C₇-C₉phenylalkyl or a group of the formula (c-I), and
b₃ is a number from 1 to 50;
a compound of the formula (C-5) 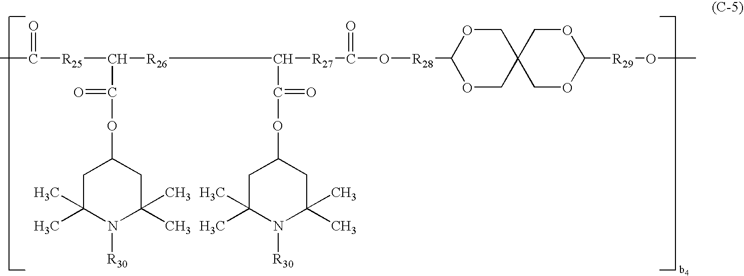
in which
R₂₅, R₂₆, R₂₇, R₂₈ and R₂₉ independently of one another are a direct bond or C₁-C₁₀alkylene,
R₃₀ has one of the meanings of R₆, and
b₄ is a number from 1 to 50; and
a product (C-6) obtainable by reacting a product, obtained by reaction of a polyamine of the formula (C-6-1) with cyanuric chloride, with a compound of the formula (C-6-2) 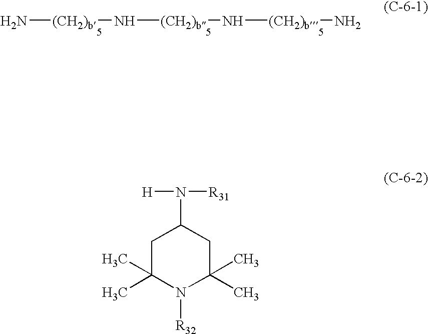
in which
b′₅, b″₅ and b′″₅ independently of one another are a number from 2 to 12,
R₃₁ is hydrogen, C₁-C₁₂alkyl, C₅-C₁₂cycloalkyl, phenyl or C₇-C₉phenylalkyl, and
R₃₂ has one of the meanings of R₆.

2. A non-agricultural article according to claim 1 wherein component (I) is a polyolefin homo- or copolymer, a starch modified polyolefin, a starch based polymer composite or a biopolymer.

3. A non-agricultural article according to claim 1 wherein component (I) is polyethylene, polypropylene, a polyethylene copolymer or a polypropylene copolymer.

4. A non-agricultural article according to claim 1 wherein component (I) is a biopolymer selected from the group consisting of polycaprolactone, polylactic acid, polyglycolic acid, polyhydroxybutyrate-valerate, polybutylene succinate, polyvinyl alcohol, polyhydroxyalcanoate and polyethylene adipate.

5. A non-agricultural article according to claim 1 wherein component (II) is a C₂-C₂₄carboxylate of Fe, Ce, Co, Mn, Cu or Vd.

6. A non-agricultural article according to claim 1 wherein component (II) is a C₂-C₂₄carboxylate of Ce, Co or Mn.

7. A non-agricultural article according to claim 1 wherein component (II) is a C₁₀-C₂₀ alkanoate of Ce, Co or Mn or a C₁₀-C₂₀alkenoate of Ce, Co or Mn.

8. A non-agricultural article according to claim 1 wherein
A₁ is hydrogen or methyl,
A₂ is a direct bond or C₂-C₆alkylene, and
n₁ is a number from 2 to 25;
n₂ and n₂* are a number from 2 to 25;
A₃ and A₄ independently of one another are hydrogen or C₁-C₄alkyl, or A₃ and A₄ together form a C₉-C₁₃alkylene group, and
the variables n₃ independently of one another are a number from 1 to 25;
n₄ is a number from 2 to 25,
A₅ and A₆ independently of one another are C₁-C₄alkyl, and
A₇ is C₁-C₄alkyl or a group of the formula (a-I) with the proviso that at least 50% of the radicals A₇ are a group of the formula (a-I);
m₁ is 1, 2 or 4,
if m₁ is 1, E₂ is C₁₂-C₂₀alkyl,
if m₁ is 2, E₂ is C₂-C₁₀alkylene or a group of the formula (b-I),
E₃ is C₁-C₄alkyl,
E₄ is C₁-C₆alkylene, and
E₅ and E₆ independently of one another are C₁-C₄alkyl, and
if m₁ is 4, E₂ is C₄-C₈alkanetetrayl;
two of the radicals E₇ are —COO—(C₁₀-C₁₅alkyl), and
two of the radicals E₇ are a group of the formula (b-II);
E₉ and E₁₀ together form C₉-C₁₃alkylene,
E₁₁ is hydrogen or a group -Z₁-COO-Z₂,
Z₁ is C₂-C₆alkylene, and
Z₂ is C₁₀-C₁₆alkyl;
E₁₄ is hydrogen, and
E₁₅ is C₂-C₆alkylene or C₃-C₅alkylidene;
E₁₇ is C₁₀-C₁₄alkyl;
E₂₄ is C₁-C₄alkoxy;
m₂ is 1, 2 or 3,
when m₂ is 1, E₂₆ is a group 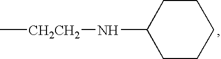
when m₂ is 2, E₂₆ is C₂-C₆alkylene, and
when m₂ is 3, E₂₆ is a group of the formula (b-IV)
the radicals E₂₇ independently of one another are C₂-C₆alkylene, and
the radicals E₂₈ independently of one another are C₁-C₄alkyl or C₅-C₈cycloalkyl; and
E₃₀ is C₂-C₈alkylene;
R₁ and R₃ independently of one another are a group of the formula (c-I),
R₂ is C₂-C₈alkylene,
R₄ and R₅ independently of one another are hydrogen, C₁-C₁₂alkyl, C₅-C₈cycloalkyl or a group of the formula (c-I), or the radicals R₄ and R₅, together with the nitrogen atom to which they are bonded, form a 5- to 10-membered heterocyclic ring, and
b₁ is a number from 2 to 25;
R₇ and R₁₁ independently of one another are hydrogen or C₁-C₄alkyl,
R₈, R₉ and R₁₀ independently of one another are C₂-C₄alkylene, and
X₁, X₂, X₃, X₄, X₅, X₆, X₇ and X₈ independently of one another are a group of the formula (c-II),
R₁₂ is hydrogen, C₁-C₄alkyl, C₅-C₈cycloalkyl or a group of the formula (c-1);
R₁₄ is C₁-C₄alkyl,
R₁₅ is C₃-C₆alkylene, and
b₂ is a number from 2 to 25;
R₁₇ and R₂₁ independently of one another are a direct bond or a group —N(X₉)—CO—X₁₀—CO—N(X₁₁)—,
X₉ and X₁₁ independently of one another are hydrogen or C₁-C₄alkyl,
X₁₀ is a direct bond.
R₁₉ and R₂₃ are C₁-C₂₅alkyl or phenyl,
R₂₀ and R₂₄ are hydrogen or C₁-C₄alkyl,
R₂₂ is C₁-C₂₅alkyl or a group of the formula (c-I), and
b₃ is a number from 1 to 25;
R₂₅, R₂₆, R₂₇, R₂₈ and R₂₉ independently of one another are a direct bond or C₁-C₄alkylene, and
b₄ is a number from 1 to 25;
b′₅, b″₅ and b′″₅ independently of one another are a number from 2 to 4, and
R₃₁ is hydrogen, C₁-C₄alkyl, C₅-C₈cycloalkyl, phenyl or benzyl.

9. A non-agricultural article according to claim 1 wherein component (III) is one or more sterically hindered amine compounds selected from the group consisting of the compounds of the formulae
(A-1-a), (A-2-a), (A-2-b), (A-3-a), (A-4-a),
(B-1-a), (B-1-b), (B-1-c), (B-1-d), (B-2-a), (B-3-a), (B-3-b), (B-4-a), (B-4-b), (B-5), (B-6-a), (B-7), (B-8-a), (B-9-a), (B-9-b), (B-9-c), (B-10-a),
(C-1-a), (C-1-b), (C-1-c), (C-1-d), (C-2-a), (C-3-a), (C-4-a), (C-4-b), (C-4-c) and (C-5-a) and a product (C-6-a); 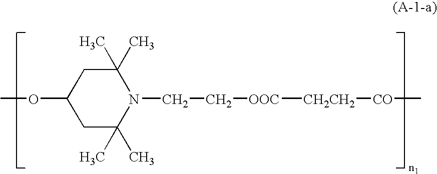
wherein n₁ is a number from 2 to 20; 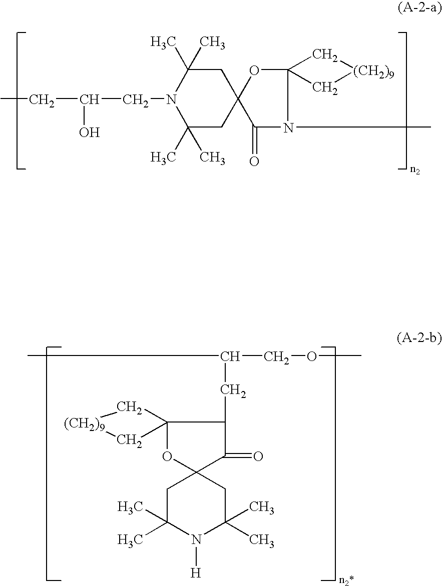
wherein n₂ and n₂* are a number from 2 to 20; 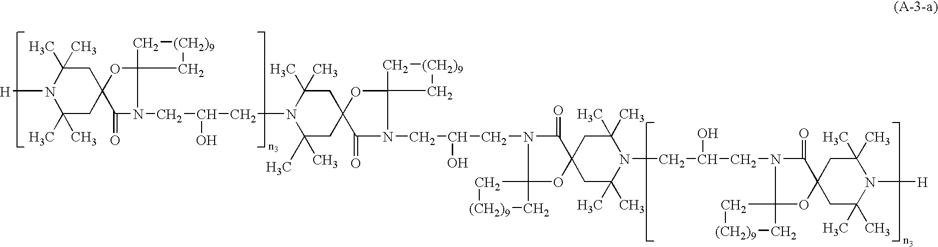
wherein the variables n₃ independently of one another are a number from 1 to 20; 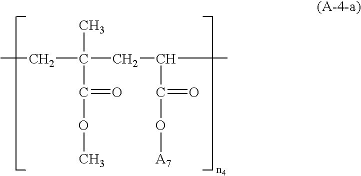
wherein n₄ is a number from 2 to 20, and
at least 50% of the radicals A₇ are a group of the formula (a-I) 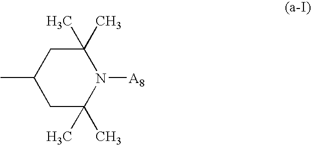
wherein A₈ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl, and the remaining radicals A₇ are ethyl; 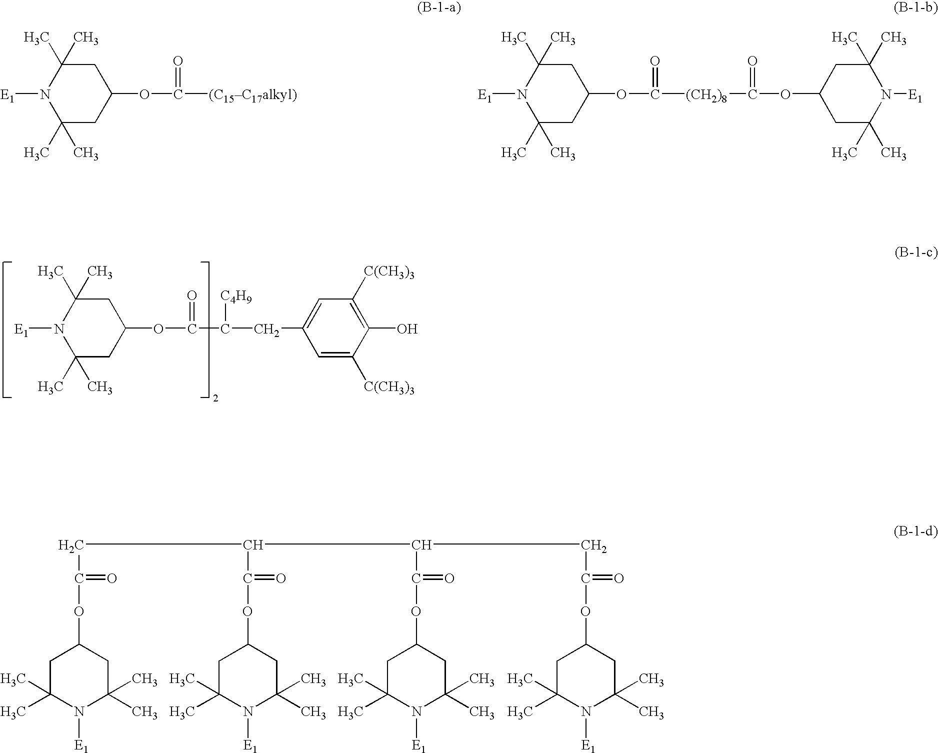
wherein E₁ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl; 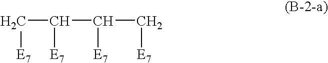
in which two of the radicals E₇ are —COO—C₁₃H₂₇ and two of the radicals E₇ are 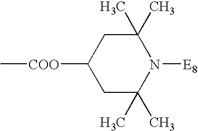
and E₈ has one of the meanings of E₁; 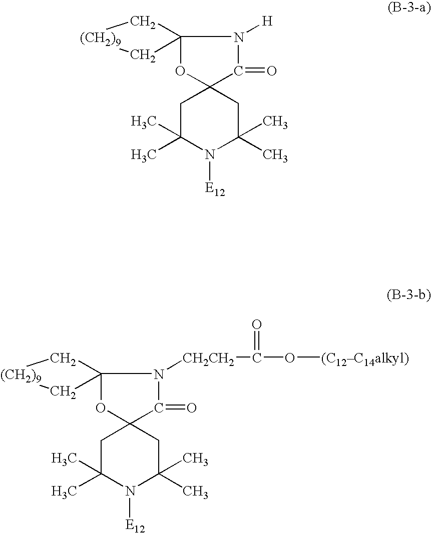
wherein E₁₂ has one of the meanings of E₁; 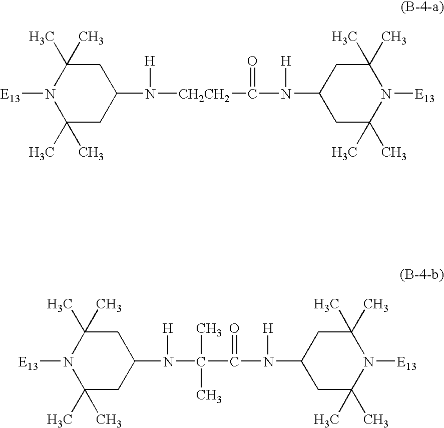
wherein E₁₃ has one of the meanings of E₁; 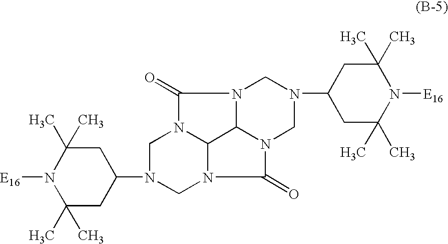
wherein E₁₆ has one of the meanings of E₁; 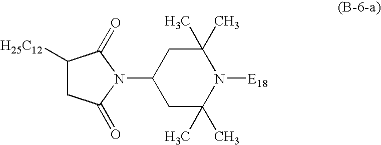
wherein E₁₈ has one of the meanings of E₁; 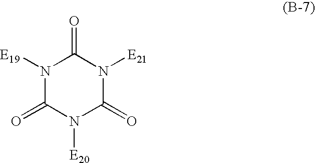
in which E₁₉, E₂₀ and E₂₁ independently of one another are a group of the formula (b-III) 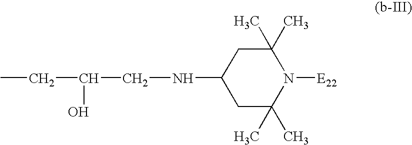
wherein E₂₂ has one of the meanings of E₁; 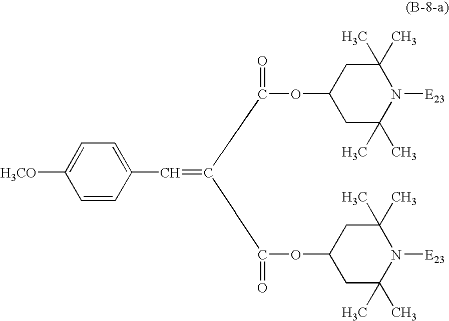
wherein E₂₃ has one of the meanings of E₁; 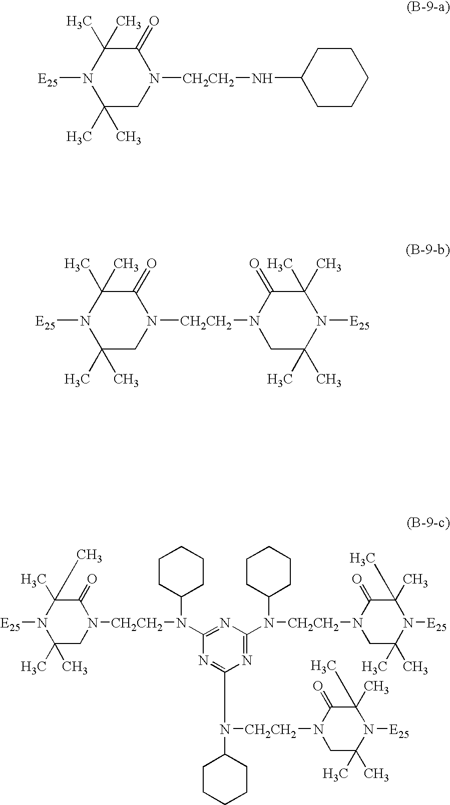
wherein E₂₅ has one of the meanings of E₁; 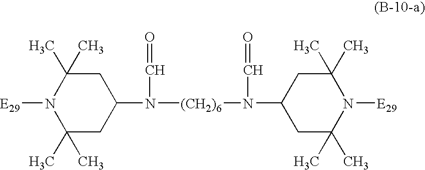
wherein E₂₉ has one of the meanings of E₁; 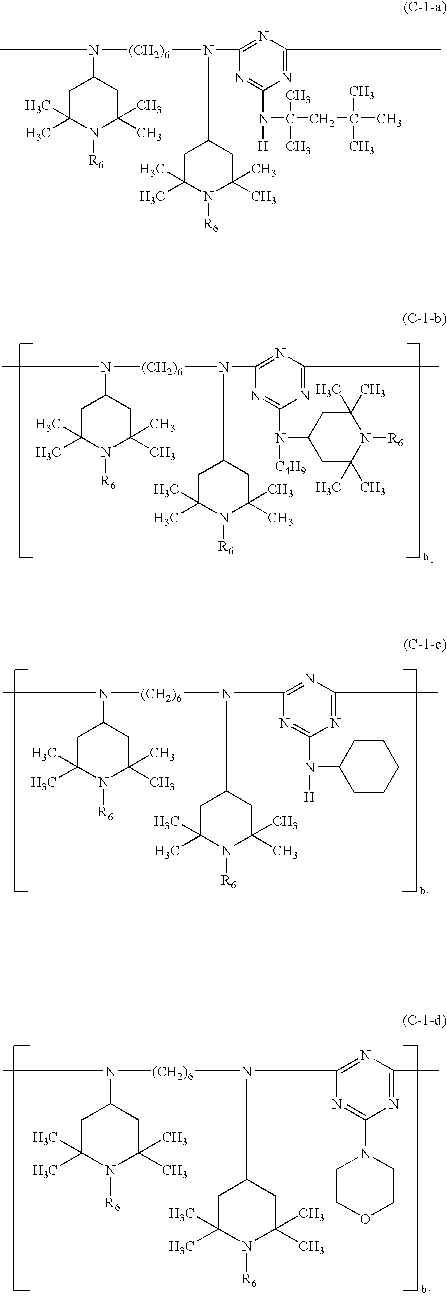
wherein b₁ is a number from 2 to 20 and R₆ is hydrogen, C₁-C₈alkyl, O, —OH, —CH₂CN, C₁-C₁₈alkoxy, C₅-C₁₂cycloalkoxy, C₃-C₆alkenyl, C₇-C₉phenylalkyl unsubstituted or substituted on the phenyl by 1, 2 or 3 C₁-C₄alkyl; or C₁-C₈acyl; 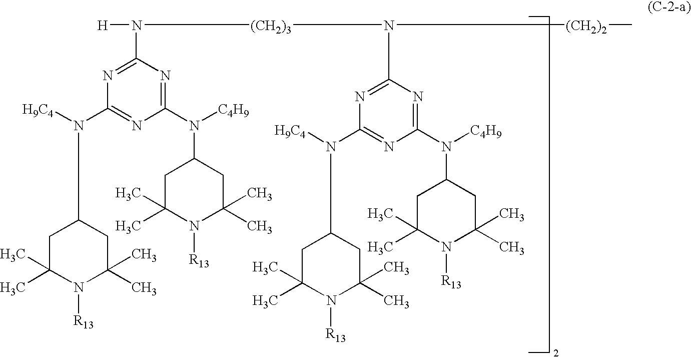
wherein R₁₃ has one of the meanings of R₆, 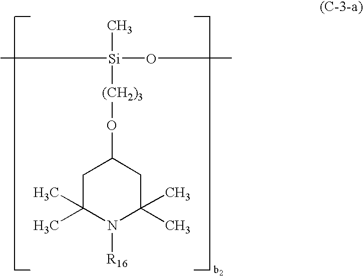
wherein b₂ is a number from 2 to 20 and R₁₆ has one of the meanings of R₆; 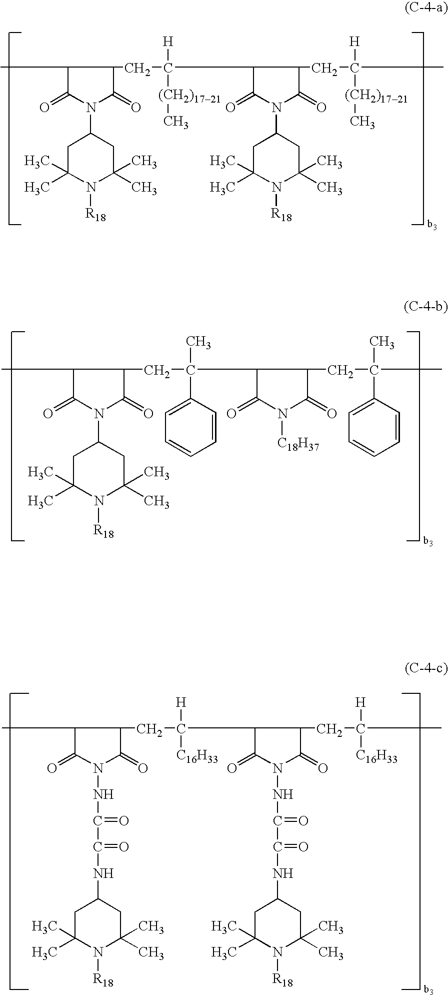
wherein b₃ is a number from 1 to 20 and R₁₈ has one of the meanings of R₆; 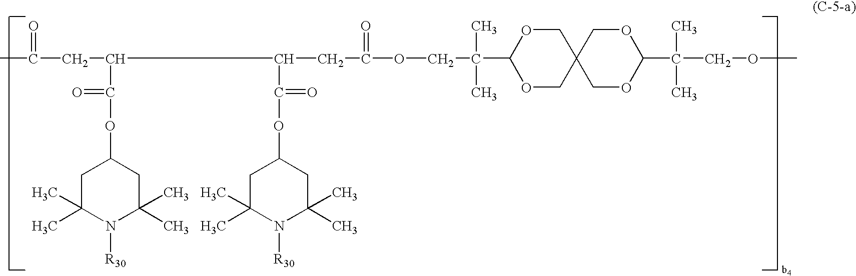
wherein b₄ is a number from 1 to 20 and R₃₀ has one of the meanings of R₆;
a product (C-6-a) obtainable by reacting a product, obtained by reaction of a polyamine of the formula (C-6-1-a) with cyanuric chloride, with a compound of the formula (C-6-2-a) 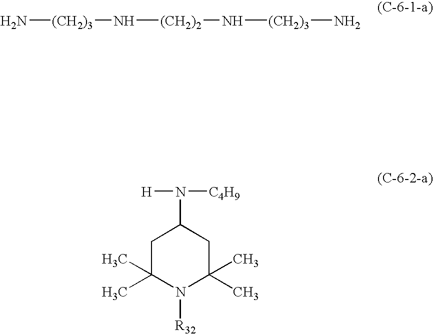
in which R₃₂ has one of the meanings of R₆.

10. A non-agricultural article according to claim 1 wherein
A₈ is hydrogen, C₁-C₄alkyl, C₁-C₁₀alkoxy, cyclohexyloxy, allyl, benzyl or acetyl;
E₁, E₈, E₁₂, E₁₃, E₁₆, E₁₈, E₂₂, E₂₃, E₂₅ and E₂₉ are hydrogen, C₁-C₄alkyl, C₁-C₁₀alkoxy, cyclohexyloxy, allyl, benzyl or acetyl;
R₆, R₁₃, R₁₆, R₁₈, R₃₀ and R₃₂ are hydrogen, C₁-C₄alkyl, C₁-C₁₀alkoxy, cyclohexyloxy, allyl, benzyl or acetyl.

11. A non-agricultural article according to claim 9 wherein
A₈, E₁, E₈, E₁₂, E₁₃, E₁₆, E₁₈, E₂₂, E₂₃, E₂₅, E₂₉, R₆, R₁₃, R₁₆, R₁₈, R₃₀ and R₃₂ are hydrogen or methyl and E₁ and R₆ additionally are C₁-C₈alkoxy.

12. A non-agricultural article according to claim 9 wherein component (III) is a compound of the formula
(A-1-a), (A-2-a), (A-2-b),
(B-1-a), (B-1-b), (B-1-c), (B-1-d), (B-2-a), (B-3-a), (B-3-b), (B-4-a), (B-4-b), (B-5), (B-6-a), (B-8-a), (B-9-b), (B-10-a),
(C-1-a), (C-1-b), (C-1-c), (C-1-d), (C-2-a), (C-3-a), (C-4-a) or (C-5-a) or a product (C-6-a).

13. A non-agricultural article according to claim 9 wherein component (III) is a compound of the formula
(A-1-a), (A-2-a), (A-2-b),
(C-1-a), (C-1-b), (C-1-c), (C-1-d), (C-2-a), (C-3-a), (C-4-a) or (C-5-a) or a product (C-6-a).

14. A non-agricultural article according to claim 9 which contains as component (III) two different sterically hindered amine compounds selected from the group consisting of the compounds of the formulae
(A-1-a), (A-2-a), (A-2-b), (A-3-a), (A-4-a),
(B-1-a), (B-1-b), (B-1-c), (B-1-d), (B-2-a), (B-3-a), (B-3-b), (B-4-a), (B-4-b), (B-5), (B-6-a), (B-7), (B-8-a), (B-9-a), (B-9-b), (B-9-c), (B-10-a),
(C-1-a), (C-1-b), (C-1-c), (C-1-d), (C-2-a), (C-3-a), (C-4-a), (C-4-b), (C-4-c) and (C-5-a) and a product (C-6-a);
with the proviso that the two different sterically hindered amine compounds are not selected from the same generic formula.

15. A non-agricultural article according to claim 1 wherein
component (III) is a compound of the formula (A-1-a), or
a compound of the formula (C-1-a) wherein R₆ is hydrogen, or
a combination of a compound of the formula (A-1-a) with a compound of the formula (C-1-a) wherein R₆ is hydrogen, or
a combination of a compound of the formula (A-1-a) with a compound of the formula (C-2-a) wherein R₁₃ is methyl, or
a combination of a compound of the formula (B-1-b) wherein E₁ is hydrogen with a compound of the formula (C-1-a) wherein R₆ is hydrogen.

16. A non-agricultural article according to claim 1 which contains in addition one or more of the following components
(IV) an antioxidant,
(V) an UV absorber,
(VI) a filler,
(VII) a pigment,
(VIII) an inorganic or organic salt of Ca, Mg, Zn or Al.

17. A non-agricultural article according to claim 1 which additionally contains an aliphatic poly hydroxy-carboxyl acid.

18. A non-agricultural article according to claim 17 wherein the aliphatic poly hydroxy-carboxyl acid is citric acid.

19. A non-agricultural article according to claim 1 which is an article selected from the group consisting of geotextiles, landfill covers, industrial covers, waste covers, temporary scaffolding sheets, building films, silt fences, flexible packaging wraps, poultry curtains and temporary shelter constructions.

20. A method for controlling the weathering resistance and the degradation of a non-agricultural organic polymer article, which comprises incorporating into the organic polymer components (II) and (III) as defined in claim 1.

21. (canceled)

22. A composition comprising components (II) and (III) as defined in claim 1.

23. A composition according to claim 22 which contains in addition one or more of the following components
(IV) an antioxidant,
(V) an UV absorber,
(VI) a filler,
(VII) a pigment,
(VIII) an inorganic or organic salt of Ca, Mg, Zn or Al.

24. A method for controlling the weathering resistance and the degradation of a non-agricultural organic polymer article which comprises incorporating into the organic polymer the composition according to claim 23.

25. A non-agricultural article according to claim 1 with the proviso that when component (I) is a polyolefin, said polyolefin does not contain an oxidizable unsaturated compound selected from the group consisting of natural rubber, styrene butadiene resin, fat and oil.

26. A non-agricultural article according to claim 1 with the proviso that when component (I) is a polyolefin, said polyolefin does not contain an oxidizable unsaturated compound.
